(19) United States
(12) Patent Application Publication
(10) Pub. No.: US 2015/0042872 A1
(43) Pub. Date: Feb. 12, 2015

(54) IMAGING DEVICE

(71) Applicant: Mitsubishi Electric Corporation, Tokyo (JP)

(72) Inventors: Daisuke SUZUKI, Tokyo (JP); Koichi YAMASHITA, Tokyo (JP); Narihiro MATOBA, Tokyo (JP)

(21) Appl. No.: 14/455,498

(22) Filed: Aug. 8, 2014

(30) Foreign Application Priority Data
Aug. 9, 2013 (JP) 2013-166074

(51) Int. Cl. H04N 5/225

(52) U.S. Cl. CPC H04N 5/2256
USPC 348/370

(57) ABSTRACT

An imaging device has an intra-plane pixel summation unit and an inter-plane pixel summation unit. In the frame of interest, the intra-plane pixel summation unit sums the signals of the pixel of interest and selected highly correlated neighboring pixels to generate an intra-plane sensitized signal and a code indicating the pattern formed by the pixel of interest and the selected pixels. The inter-plane pixel summation unit selects pixels for summation from among the pixels positioned identically to the pixel of interest and pixels in the neighborhood of the identically positioned pixels in one or more frames neighboring the frame of interest on the basis of the agreement or disagreement of their pixel summing pattern codes and correlation of their intra-plane sensitized signals. In a Bayer array imaging device, enhanced sensitivity is obtained without causing color mixing.

### BACKGROUND OF THE INVENTION

1. Field of the Invention

The present invention relates to an imaging device that can capture images with improved sensitivity in low illumination environments.

2. Description of the Related Art

Some known imaging devices are configured to obtain improved sensitivity and an improved signal-to-noise (S/N) ratio by executing a function that sums all the digital signals for the preceding N pixels (see, for example, Japanese Patent Application Publication No. 2000-184274, in particular paragraph 0010 on page 4).

A problem with these known imaging devices is that since they add the captured image signals from a continuous row of adjacent pixels, when a color imaging element is used, the colors mix and a color signal cannot be reproduced.

This invention addresses this problem with the object of enabling an image signal of sufficiently high sensitivity to be obtained without color mixing when image signals read from a color imaging element are summed.

### SUMMARY OF THE INVENTION

The present invention provides an imaging device comprising an imaging signal generation unit, an intra-plane pixel summation unit, and an inter-plane pixel summation unit.

The imaging signal generation unit is configured to capture images and generate an imaging signal indicating a pixel value for each pixel in a plurality of pixels constituting a sequence of temporally consecutive frames.

The intra-plane pixel summation unit is configured to:

receive the imaging signal generated by the imaging signal generation unit,

sequentially specify the pixels in each of the consecutive frames,

select, for each specified pixel, an area consisting of pixels with high mutual correlation, from among a plurality of areas having predetermined relative positions or orientations with respect to the specified pixel,

sum the pixel values of the pixels in the selected area,

output a resulting sum as an intra-plane sensitized signal of the specified pixel, and

output a pixel summing pattern code indicating the relative position or orientation of the selected area.

The inter-plane pixel summation unit is configured to:

sequentially specify the consecutive frames as a frame of interest,

sequentially specify the pixels in the frame of interest as a pixel of interest,

select, for each pixel of interest, a pixel from each of one or more frames neighboring the frame of interest, on a basis of correlations of the intra-plane sensitized signal of the pixel of interest with the intra-plane sensitized signals of a pixel positioned identically to the pixel of interest and pixels in a neighborhood of the identically positioned pixel, results of comparisons of the correlations with a correlation decision threshold value, and the relative position or orientation of each of the selected areas with respect to the specified pixel,

add the intra-plane sensitized signals of the selected pixels in the one or more frames neighboring the frame of interest to the intra-plane sensitized signal of the pixel of interest, and

output a resulting sum as a three-dimensionally sensitized signal.

The present invention enables the imaging signal read from an imaging element to be adequately boosted in sensitivity, thereby making subjects visible in environments with extremely low illumination. When the imaging element is a color imaging element, this effect is obtained without mixing of colors.

### BRIEF DESCRIPTION OF THE DRAWINGS

In the attached drawings:

FIG. 1 is a block diagram showing the imaging device in a first embodiment of the present invention;

FIG. 2 shows a pixel spatial arrangement of pixels centered on a pixel of interest, having pixel values output from the imaging element in FIG. 1;

FIG. 3 shows the arrangement of neighboring pixels in the pixel spatial arrangement in FIG. 2 when the pixel of interest is a green pixel;

FIG. 4 shows the arrangement of neighboring pixels in the pixel spatial arrangement in FIG. 2 when the pixel of interest is a red pixel;

FIG. 5 shows the arrangement of neighboring pixels in the pixel spatial arrangement in FIG. 2 when the pixel of interest is a blue pixel;

FIG. 6 is a block diagram showing an example of the three-dimensional pixel summation unit (6) in FIG. 1;

FIG. 7 is a block diagram showing an example of the intra-plane pixel summation unit (20) in FIG. 6;

FIG. 8 is a block diagram showing an example of the pixel extractor (21) in FIG. 7;

FIG. 9 is a block diagram showing an example of the area selector (22) in FIG. 7;

FIGS. 10A to 10D show first to fourth combination patterns used in the pixel summation unit when the pixel of interest is a green pixel;

FIGS. 11A to 11D show fifth to eighth combination patterns used in the pixel summation unit when the pixel of interest is a green pixel;

FIGS. 12A to 12D show ninth to twelfth combination patterns used in the pixel summation unit when the pixel of interest is a green pixel;

FIGS. 13A to 13D show first to fourth combination patterns used in the pixel summation unit when the pixel of interest is a red pixel;

FIGS. 14A to 14D show first to fourth combination patterns used in the pixel summation unit when the pixel of interest is a blue pixel;

FIG. 15 is a block diagram showing an example of the selective summation unit (23) in FIG. 7;

FIG. 16 is a block diagram showing an example of the inter-plane pixel summation unit (30) in FIG. 6;

FIG. 17 is one part of a block diagram showing an example of the pixel extractor (31) in FIG. 16;

FIG. 18 is another part of the block diagram showing an example of the pixel extractor (31) in FIG. 16;

FIG. 19 is a block diagram showing an exemplary one of the pixel selectors (351) in FIG. 16;

FIG. 20 is a block diagram showing an exemplary one of the pattern discriminators (361) in FIG. 19, together with the corresponding correlation discriminator;

FIG. 21 is a block diagram showing an exemplary one of the discrimination units (3611) in FIG. 20;

FIG. 22 is a block diagram showing a summation pixel selector (35b) used in a second embodiment of the present invention;

FIG. 23 is a block diagram showing the second pattern discriminator (662) in FIG. 22, together with the corresponding correlation discriminator (682);

FIG. 24 is a block diagram showing an exemplary one of the discrimination units (6621) in FIG. 23;

FIG. 25 is a block diagram showing the first pattern discriminator (661) in FIG. 22, together with the corresponding correlation discriminator (681);

FIG. 26 is a block diagram showing an exemplary one the discrimination units (6611) in FIG. 25;

FIG. 27 is a block diagram showing an inter-plane pixel summation unit (30b) used in a third embodiment of the present invention;

FIG. 28 is a block diagram showing the imaging device in a fourth embodiment of the present invention;

FIG. 29 is a block diagram showing the imaging device in a fifth embodiment of the present invention;

FIGS. 30A to 30E show relationships among subject illuminance, lens aperture, the amplification factor in the programmable gain amplifier, the sensitivity multiplier in the pixel summation unit, the exposure time in the imaging section, and the amplitude of the output signal of the pixel summation unit; and

FIG. 31 is a block diagram showing the imaging device in a sixth embodiment of the present invention.

### DETAILED DESCRIPTION OF THE INVENTION

### First Embodiment

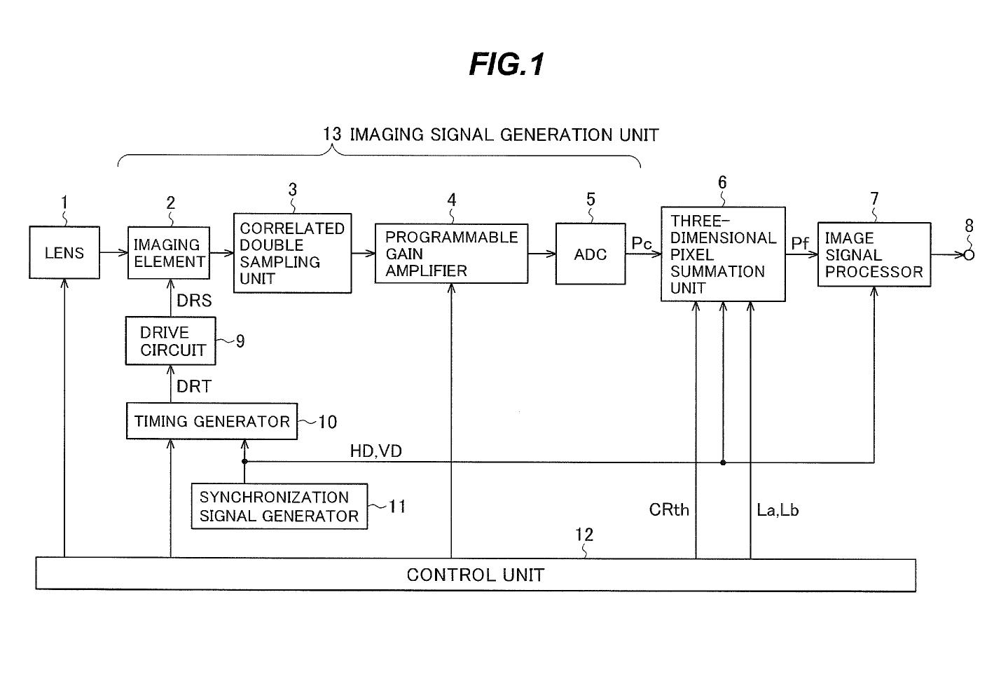

FIG. 1 shows an imaging device in a first embodiment of the present invention. The illustrated imaging device captures images continuously and outputs a sequence of image signals representing a sequence of temporally consecutive frames. In the following description, the images are color images consisting of red, green, and blue pixels.

In FIG. 1, a lens 1 focuses a subject image on the imaging plane of a CCD imaging element 2.

The CCD imaging element (CCD) 2 has red pixels for detecting red light (first color component light), green pixels for detecting green light (second color component light), and blue pixels for detecting blue light (third color component light) arranged in a Bayer array as shown in FIGS. 3 to 5 to be described later.

The red pixels, the green pixels, and the blue pixels are formed, for example, of photoelectric conversion elements with color filters that selectively transmit red light, photoelectric conversion elements with color filters that selectively transmit green light, and photoelectric conversion elements with color filters that selectively transmit blue light.

The red light, the green light, and the blue light (the first color component light, second color component light, and third color component light) are detected, i.e., photoelectrically converted by the red pixels, the green pixels, and the blue pixels into electric charges. The electric charges generated by the photoelectric conversion are transferred through the imaging element and output as an electrical signal (imaging signal). The imaging signal is output sequentially, frame by frame.

The imaging signal includes red signals (representing the value of the first color component) from the red pixels, green signals (representing the value of the second color component) from the green pixels, and blue signals (representing the value of the third color component) from the blue pixels.

Noise and the like are eliminated from the imaging signal output from the CCD imaging element 2 by a correlated double sampling (CDS) unit 3.

A programmable gain amplifier (PGA) 4 amplifies the output signal of the correlated double sampling unit 3 with a gain controlled by a control signal output from a control unit 12 and outputs the amplified signal.

An analog to digital converter (ADC) 5 converts the output signal from the programmable gain amplifier 4 to a digital signal Pc.

The imaging element 2, the correlated double sampling unit 3, the programmable gain amplifier 4, and the ADC 5 constitute an imaging signal generation unit 13 that sequentially generates an imaging signal, frame by frame, with a plurality of color components obtained by imaging a subject. The imaging signal represents a pixel value for each of the plurality of pixels constituting each of the temporally consecutive frames.

A three-dimensional pixel summation unit 6 receives the imaging signal Pc output from the ADC 5 and performs intra-plane pixel summation and inter-plane pixel summation, thereby generating a three-dimensionally sensitized signal.

In the intra-plane pixel summation, in each of the consecutive frames, the pixels are sequentially specified, and from among the pixels which are within the same frame and which neighbor the specified pixel, pixels having pixel values highly correlated with the pixel value of the specified pixel are selected, and pixel values of the selected pixels and the pixel value of the specified pixel are summed and the resulting sum is output as the intra-plane sensitized signal for the specified pixel.

In the inter-plane pixel summation, the consecutive frames are sequentially specified as a frame of interest, and the pixels in the frame of interest are sequentially specified as a pixel of interest. For each pixel of interest, the correlativity of the intra-plane sensitized signal of the pixel of interest with the intra-plane sensitized signal of the pixel positioned identically to the pixel of interest and the intra-plane sensitized signals of the pixels in the neighborhood of the identically positioned pixel in each of one or more frames neighboring the frame of interest is compared with a correlation decision threshold value CRth to determine the presence or absence of correlation. From among the pixels in each of the neighboring frames determined to be correlated as a result of this comparison, a pixel with relatively high correlativity, e.g., the pixel with the highest correlativity is selected. Then, the intra-plane sensitized signals of the pixels respectively selected in the one or more neighboring frames and the intra-plane sensitized signal of the pixel of interest are summed, and the resulting sum is output as a three-dimensionally sensitized signal.

When an absolute difference value is used as a correlativity index, a smaller absolute difference indicates higher correlativity, so that an absolute difference equal to or less than the threshold value CRth indicates correlativity equal to or greater than the reference value. Conversely, when an index whose value increases with increasing correlativity is used, an index equal to or greater than the threshold value indicates a correlativity value equal to or greater than the reference value.

The correlation decision threshold value CRth is supplied from the control unit 12.

The intra-plane sensitized signals of the sequentially specified pixels are obtained in the intra-plane pixel summation and then the inter-plane pixel summation is performed by use of the intra-plane sensitized signals of the pixels in a plurality of frames. Accordingly, at any given point in time, the pixel of interest in the frame of interest in the inter-plane pixel summation is not the same as the ‘specified pixel’ in the intra-plane pixel summation. But in the description of the intra-plane pixel summation, the ‘specified pixel’ will be referred to as the pixel of interest.

An image signal processor 7 performs color synchronization processing, gradation correction processing, noise reduction processing, outline correction processing, white balance adjustment processing, signal amplitude adjustment processing, and color correction processing on the signal output from the three-dimensional pixel summation unit 6, and outputs the resultant video signal through a video signal output terminal 8.

A synchronization signal generator 11 generates a vertical synchronization signal VD and a horizontal synchronization signal HD and supplies them to the three-dimensional pixel summation unit 6, the image signal processor 7, and a timing generator 10.

The timing generator 10 generates a drive timing signal DRT for the CCD imaging element 2 and supplies it to a drive circuit 9. Based on the drive timing signal DRT output from the timing generator 10, the drive circuit 9 generates a drive signal DRS for the CCD imaging element 2. The CCD imaging element 2 performs photoelectric conversion and charge transport based on the drive signal DRS output from the drive circuit 9.

The control unit 12 performs control of the aperture of the lens 1, control of the timing of charge reading and forced charge flushing from the photoelectric conversion elements of the CCD imaging element 2 (accordingly, control of the charge accumulation time (i.e., exposure time), and control of the amplification factor of the programmable gain amplifier 4, and control of the pixel summation, including setting of sensitivity multipliers La and Lb for the three-dimensional pixel summation unit 6.

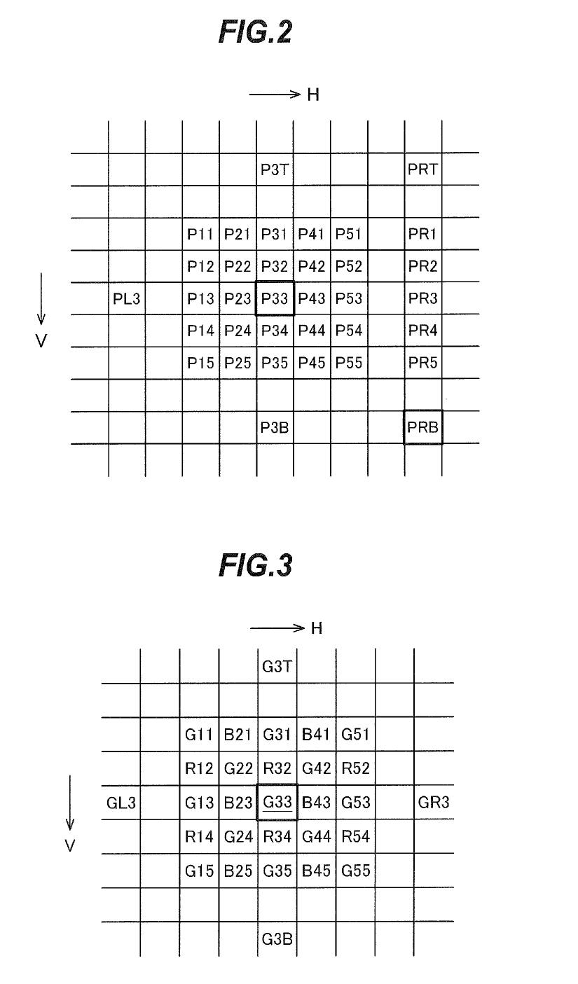

The pixels on the image plane of the imaging element 2 are oriented in the horizontal direction (row direction) H and in the vertical direction (column direction) V, and are thereby arranged in a matrix form, as shown in FIG. 2. The position of each pixel on the image plane is represented by coordinates (h, v), where h designates horizontal position and v designates vertical position. The pixel at coordinates (h, v) will be denoted Phv. Two horizontally adjacent pixels differ by 1 in the value of h, and two vertically adjacent pixels differ by 1 in the value of v. That is, the distance (pixel pitch) between two adjacent pixels is 1.

FIG. 2 shows a block of pixels measuring five pixels horizontally and five pixels vertically (a 5×5 pixel range) centered on a pixel of interest P33 used in the intra-plane pixel summation, and some further neighboring pixels (in a range measuring nine pixels horizontally and nine pixels vertically).

FIGS. 3, 4, and 5 illustrate the arrangement of red pixels, green pixels, and blue pixels. The red pixels, green pixels, and blue pixels are arranged in a checkerboard pattern formed by repetition of a basic unit. The basic unit is a four-pixel block measuring two pixels horizontally and two pixels vertically, with two green pixels located on one diagonal line and a red pixel and a blue pixel located on the other diagonal line. The symbols Rhv, Ghv, and Bhv respectively indicate a red pixel, a green pixel, and a blue pixel located at coordinates (h, v). The coordinates of the pixel of interest are (h, v)=(3, 3) also in these drawings.

FIG. 3 shows the arrangement of pixels in a 5×5 pixel area and further neighboring pixels when the pixel of interest is a green pixel (a pixel with a green filter) in the pixel spatial arrangement in FIG. 2. The pixels of the individual colors are arranged such that a four-pixel block measuring two pixels horizontally and two pixels vertically, consisting of R32, G33, B43, and G42, for example, is repeated as a basic unit.

FIG. 3 illustrates an exemplary case in which the pixels adjacent to (preceding and following) G33 on the same row are blue pixels, but there is an arrangement pattern in which a green pixel, such as G22, is adjacent to red pixels in the same row. In that case, red pixels and blue pixels are interchanged in the color sequence, but only green pixels are added when the pixel of interest is a green pixel, so that the description of one color sequence applies to the other color sequence as well, with minor modifications.

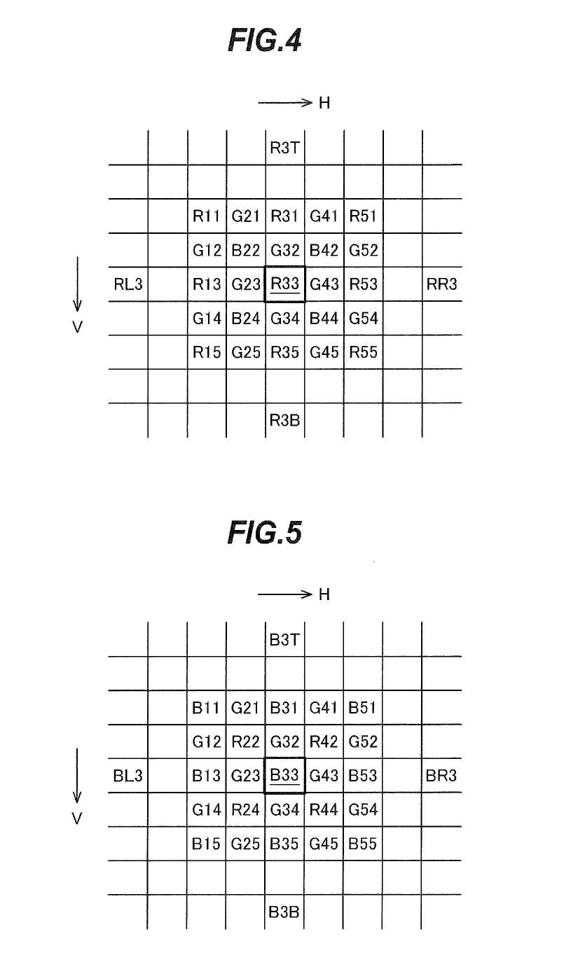

FIG. 4 shows the arrangement of pixels in a 5×5 pixel area and further neighboring pixels when the pixel of interest is a red pixel (a pixel with a red filter) in the pixel spatial arrangement in FIG. 2. The pixels of the individual colors are arranged such that a four-pixel block measuring two pixels horizontally and two pixels vertically, consisting of R33, G34, B44, and G43, for example, is repeated as a basic unit.

FIG. 5 shows the arrangement of pixels in a 5×5 pixel area and further neighboring pixels when the pixel of interest is a blue pixel (a pixel with a blue filter) in the pixel spatial arrangement in FIG. 2. The pixels of the individual colors are arranged such that a four-pixel block measuring two pixels horizontally and two pixels vertically, consisting of R22, G23, B33, and G32, for example, is repeated as a basic unit.

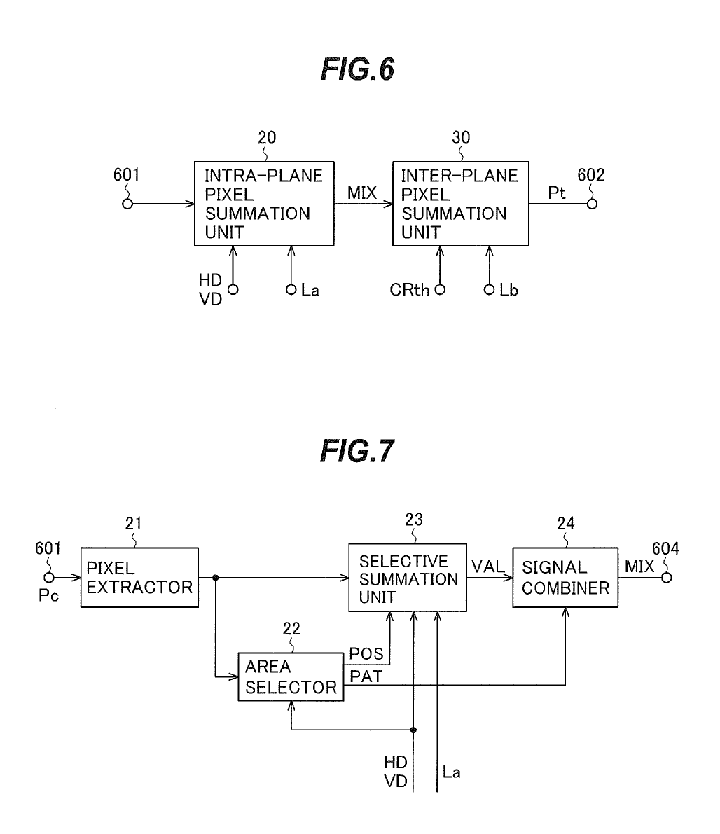

The three-dimensional pixel summation unit 6 has an intra-plane pixel summation unit 20 and an inter-plane pixel summation unit 30 as shown in FIG. 6.

The imaging signal Pc of the red pixels, the green pixels, and the blue pixels arranged in a Bayer array is supplied from the ADC 5 to the intra-plane pixel summation unit 20 through an input terminal 601.

Based on the imaging signal generated in the imaging signal generation unit 13, the intra-plane pixel summation unit 20 sequentially specifies the pixels in each of the consecutive frames. From among the pixels neighboring the specified pixel, the intra-plane pixel summation unit 20 selects pixels with pixel values showing high correlativity with the pixel value of the specified pixel, sums the pixel values of the selected pixels and the specified pixel, and outputs the resulting sum as an intra-plane sensitized signal VAL of (pertaining to) the specified pixel.

The inter-plane pixel summation unit 30 sequentially specifies each of the consecutive frames as a frame of interest and sequentially specifies each of the pixels in the frame of interest as a pixel of interest. Then, from among a pixel positioned identically to the specified pixel of interest and pixels in the neighborhood of the identically positioned pixel in each of one or more frames neighboring the frame of interest, the inter-plane pixel summation unit 30 selects a pixel whose intra-plane sensitized signal VAL shows high correlativity with the intra-plane sensitized signal of the pixel of interest. Then, the inter-plane pixel summation unit 30 sums the intra-plane sensitized signals VAL of the pixels selected in the one or more neighboring frames and the intra-plane sensitized signal VAL of the pixel of interest, and outputs the resulting sum as a three-dimensionally sensitized signal Pf.

The intra-plane sensitized signal VAL is obtained by summing, for example, four values of the original imaging signal in the intra-plane pixel summation unit 20. In this case, the sensitivity of the original imaging signal is boosted by a factor of up to four. The three-dimensionally sensitized signal is then obtained by summing, for example, five values of the intra-plane sensitized signal VAL in the inter-plane pixel summation unit 30. Then, the sensitivity can be boosted further by a factor of up to five. As a result, it is possible to obtain the three-dimensionally sensitized signal Pf with a sensitivity boosted up to twenty times that of the original imaging signal.

The inter-plane pixel summation unit 30 supplies the three-dimensionally sensitized signal Pf from an output terminal 602 to the image signal processor 7.

As shown in FIG. 7, the intra-plane pixel summation unit 20 includes a pixel extractor 21, an area selector 22, a selective summation unit 23, and a signal combiner 24.

The imaging signal Pc output from the ADC 5 is input to the input terminal 601 of the three-dimensional pixel summation unit 6. A composite signal MIX in which the intra-plane sensitized signal VAL is combined with a pixel summing pattern code PAT is output from an output terminal 604.

The horizontal synchronization signal HD and the vertical synchronization signal VD output from the synchronization signal generator 11 in FIG. 1 are input to the area selector 22 and the selective summation unit 23.

Also input to the selective summation unit 23 is information indicating the sensitivity multiplier La output from the control unit 12 in FIG. 1.

The imaging signal Pc supplied to the pixel extractor 21 via the input terminal 601 indicates the pixel values of the red pixels, the green pixels, and the blue pixels arranged in a Bayer array as described above.

The pixel extractor 21 delays the input imaging signal Pc by different times to simultaneously extract the pixel values of a plurality of pixels which are in the same frame, are mutually neighboring, and have the same color filter (detects light of the same color component) as the pixel of interest. The pixel in the center of the plurality of pixels is treated as the pixel of interest and the rest are treated as reference pixels. Therefore, the above extraction process can be described as a process of simultaneously extracting the pixel value of the pixel of interest and the pixel values of a plurality of pixels neighboring the pixel of interest in the same frame and having the same color filter (detecting light of the same color component) as the pixel of interest. As the extracted pixels sequentially change, the above process can also be described as a process of sequentially specifying pixels in the frame as the pixel of interest and simultaneously extracting the pixel value of the specified pixel and the pixel values of a plurality of pixels neighboring the specified pixel and having the same color filter (detecting light of the same color component) as the specified pixel.

The plurality of pixels having the same color filter (detecting light of the same color component) as the pixel of interest generate electrical signals representing the same color component as the pixel of interest.

The area selector 22 receives the signals indicating the pixel values of the pixel of interest and the neighboring reference pixels extracted by the pixel extractor 21, and forms a plurality of combinations consisting of the pixel of interest and one or more neighboring pixels, and hence a plurality of pixel areas respectively constituted of the combinations. From among the plurality of pixel areas thus formed, the area selector 22 selects a pixel area consisting of pixels that are highly correlated with each other, and outputs the selected pixel area. Since each pixel area includes the pixel of interest, selecting a pixel area consisting of pixels that are highly correlated with each other enables selection of a pixel area consisting of pixels that are highly correlated with the pixel of interest. To select a pixel area consisting of pixels that are highly correlated with each other, the combination with the smallest difference between maximum and minimum pixel values may be selected.

Information (summation pixel position information) POS indicating the positions of the pixels constituting the selected pixel area is output to the selective summation unit 23.

Along with the summation pixel position information POS, information indicating the pattern (type) of the selected pixel area (e.g., information indicating to which of a plurality of predetermined types it belongs) is generated as a pixel summing pattern code PAT, and is output to the signal combiner 24. The patterns (types) used herein are defined by, for example, the relative position or direction of the selected area with respect to the pixel of interest and the shape of the area.

For example, as the plurality of pixel areas, a plurality of pixel areas with different patterns, e.g., a plurality of pixel areas with different relative positions or directions with respect to the pixel of interest, or a plurality of pixel areas differing not only in relative position or direction but also shape are prepared, and from among the prepared plurality of pixel areas, the pixel area with the highest correlativity is selected and information indicating the pattern of the selected area is output as the pixel summing pattern code PAT.

The selective summation unit 23 receives the imaging signal extracted by the pixel extractor 21 for each pixel of interest, sums the values of the imaging signal of the pixels included in the pixel area selected by the area selector 22, that is, the pixels specified by the summation pixel position information POS, and outputs the resulting sum as an intra-plane sensitized signal VAL. The intra-plane sensitized signal VAL output from the selective summation unit 23 is supplied to the signal combiner 24.

The signal combiner 24 combines the intra-plane sensitized signal VAL output from the selective summation unit 23 and the pixel summing pattern code PAT into the composite signal MIX, and outputs the composite signal MIX.

For example, if the intra-plane sensitized signal VAL is a 12-bit signal and the pixel summing pattern code PAT is a 4-bit code, then the composite signal MIX is a 16-bit signal.

The composite signal MIX generated by the signal combiner 24 is supplied through the output terminal 604 to the inter-plane pixel summation unit 30.

The pixel extractor 21, the area selector 22, the selective summation unit 23, and the signal combiner 24 will now be described in detail.

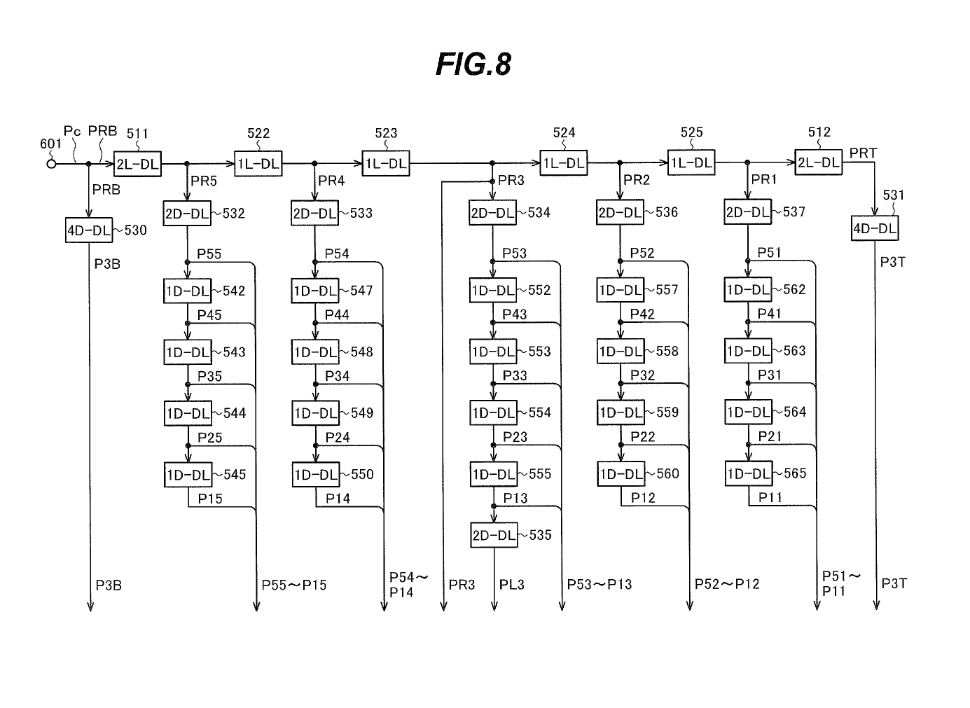

The pixel extractor 21 is configured as shown, for example, in FIG. 8.

In FIG. 8, 1L-DL indicates a one-line delay unit, 2L-DL indicates a two-line delay unit, 1D-DL indicates a one-pixel (one-dot) delay unit, 2D-DL indicates a two-pixel delay unit, and 4D-DL indicates a four-pixel delay unit.

The pixel extractor 21 is configured by connecting two-line delay units 511 and 512, one-line delay units 522 to 525, four-pixel delay units 530 and 531, two-pixel delay units 532 to 537, and one-pixel delay units 542 to 545, 547 to 550, 552 to 555, 557 to 560, and 562 to 565 as shown in the drawing, delays the imaging signal Pc by various different times, and outputs signals of mutually neighboring pixels.

Among the signals output from the pixel extractor 21, the signal output from delay unit 553 is used as the signal of the pixel of interest P33 (FIG. 2). If the signal from delay unit 553 is used as the signal of the pixel of interest P33 (FIG. 2), then the imaging signal Pc input to the input terminal 601 is the signal of a pixel PRB (FIG. 2), and the pixel values (pixel signals indicating the pixel values) for the pixel of interest P33 and its neighboring pixels P11 to P55, PL3, P3T, P3B, and PR1 to PR5 are output simultaneously.

In the following description, the same characters will be used to denote a pixel, its pixel value, and its pixel signal. For example, the pixel value and the pixel signal of the pixel P33 will also be denoted P33.

The processing by each delay unit in the pixel extractor 21 will now be described in detail.

The pixel signal PRB is sequentially delayed by the two-line delay unit 511, the one-line delay units 522 to 525, and the two-line delay unit 512 to output the pixel signals PR5, PR4, PR3, PR2, PR1, and PRT respectively delayed by two, three, four, five, six, and eight lines with respect to the pixel signal PRB.

The pixel signal PRB is delayed by the four-pixel delay unit 530 and output as the pixel signal P3B.

The pixel signal PR5 output from the two-line delay unit 511 is delayed by two pixels in the two-pixel delay unit 532 and further delayed by one pixel each in the one-line delay units 542 to 545 to the output pixel signals P55, P45, P35, P25, and P15 respectively delayed by two, three, four, five, and six pixels from the pixel signal PR5.

The pixel signal PR4 output from the one-line delay unit 522 is delayed by two pixels in the two-pixel delay unit 533 and further delayed by one pixel each in the one-line delay units 547 to 550 to output the pixel signals P54, P44, P34, P24, and P14 respectively delayed by two, three, four, five, and six pixels from the pixel signal PR4.

The pixel signal PR3 output from the one-line delay unit 523 is delayed by two pixels in the two-line delay unit 534, then further delayed by one pixel each in the one-pixel delay units 552 to 555, and still further delayed by two pixels in the two-pixel delay unit 535 to output the pixel signals P53, P43, P33, P23, P13, and PL3 respectively delayed by two, three, four, five, six, and eight pixels from the pixel signal PR3.

The pixel signal PR2 output from the one-line delay unit 524 is delayed by two pixels in the two-pixel delay unit 536 and further delayed by one pixel each in one-pixel delay units 557 to 560 to output the pixel signals P52, P42, P32, P22, and P12 respectively delayed by two, three, four, five, and six pixels from the pixel signal PR2.

The pixel signal PR1 output from the one-line delay unit 525 is delayed by two pixels in the two-pixel delay unit 537 and further delayed by one pixel each in the one-pixel delay units 562 to 565 to output the pixel signals P51, P41, P31, P21, and P11 respectively delayed by two, three, four, five, and six pixels from the pixel signal PR1.

The pixel signal PRT output from the two-line delay unit 512 is delayed by the four-pixel delay unit 531 and output as the pixel signal P3T.

The pixel signals P55 to P11, P3B, PR3, PL3, and P3T respectively indicate the pixel values of the pixels P55 to P11, P3B, PR3, PL3, and P3T, which are simultaneously output from the pixel extractor 21 upon input of the pixel signal PRB and supplied to the area selector 22 and the selective summation unit 23.

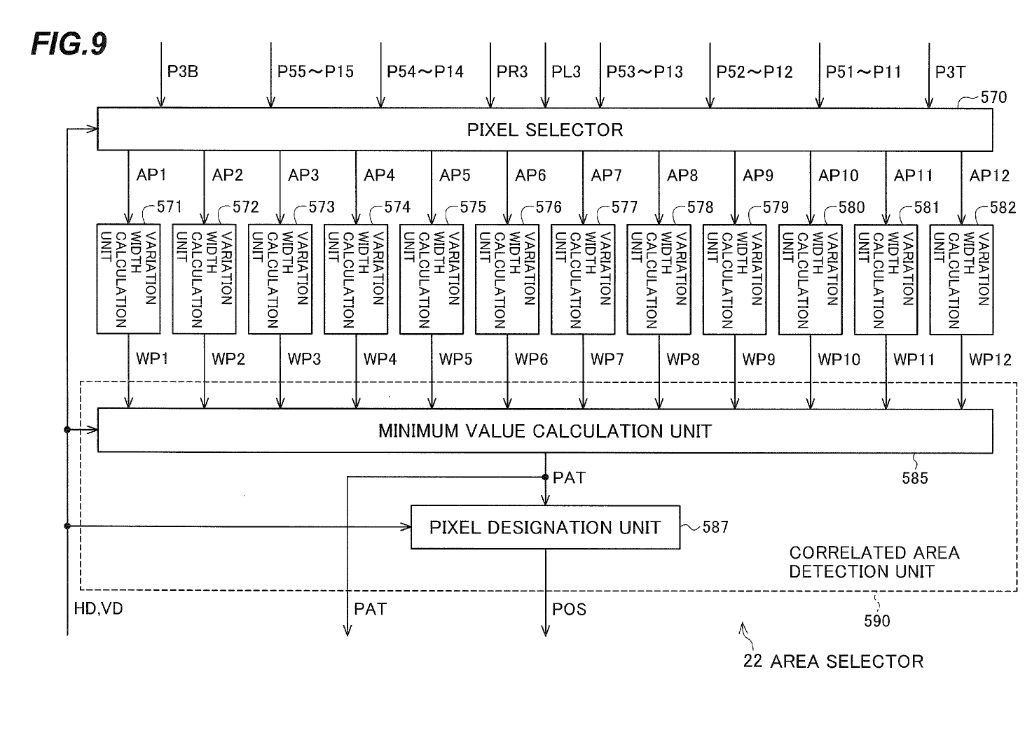

The area selector 22 includes, for example, a pixel selector 570, variation width calculators 571 to 582, a minimum value calculation unit 585, and a pixel designation unit 587 as shown in FIG. 9.

The horizontal synchronization signal HD and the vertical synchronization signal VD output from the synchronization signal generator 11 in FIG. 1 are supplied to the pixel selector 570, the minimum value calculation unit 585, and the pixel designation unit 587.

On the basis of the horizontal synchronization signal HD and the vertical synchronization signal VD, the pixel selector 570 determines the pixel position of the pixel of interest P33 and identifies the pixel position on the color filter array. The pixel selector 570 also determines whether the pixel of interest is a red pixel, a green pixel, or a blue pixel.

Then, the pixel selector 570 receives the pixel signals P55 to P11, P3B, PR3, PL3, and P3T supplied from the pixel extractor 21 and generates a plurality of combinations (or pixel areas) each consisting of the pixel of interest and neighboring pixels. For each pixel of interest, a plurality of such combinations are generated.

If pixels highly correlated with the pixel of interest can be properly selected as the pixels to be used in the pixel summation (summation pixels) in the selective summation unit 23, degradation in image resolution after the pixel summation can be mitigated. Therefore, the area selector 22 prepares or forms a plurality of combinations of the pixel of interest and neighboring pixels in various different patterns, and determines the correlation with respect to each combination, and the selective summation unit 23 performs the pixel summation by using pixels belonging to the combination with the highest correlation.

The degree of correlation of each combination is evaluated on the basis of the amount of change in the pixel value given by the difference between the maximum value (the greatest pixel value) and the minimum value (the smallest pixel value) among the pixel values of the pixels belonging to the combination. Specifically, the combination with the smallest amount of change is selected as the combination with the highest correlation.

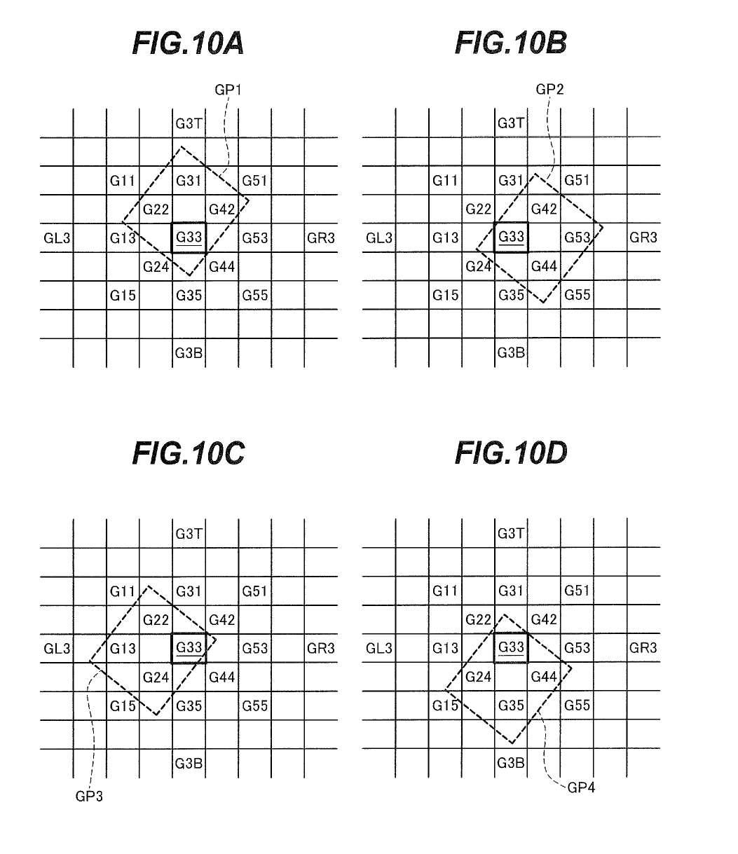

The patterns of four-pixel combinations used for performing four-pixel summation when the pixel of interest is a green pixel in the pixel spatial arrangement in FIG. 2 are shown in FIGS. 10A to 10D, 11A to 11D, and 12A to 12D. In the four-pixel summation for a green pixel, the pattern with the highest correlation is determined from twelve combination patterns.

FIG. 10A shows an upper block pattern combination GP1 consisting of the pixel of interest and upwardly neighboring pixels, specifically, the pixel of interest G33, the pixel G31 two lines ahead of the pixel of interest, the pixel G22 one line and one pixel ahead of the pixel of interest, and the pixel G42 one line ahead of and one pixel behind the pixel of interest.

FIG. 10B shows a right block pattern combination GP2 consisting of the pixel of interest and right neighboring pixels, specifically, the pixel of interest G33, the pixel G53 two lines behind the pixel of interest, the pixel G42 one line ahead of and one pixel behind the pixel of interest, and the pixel G44 one line and one pixel behind the pixel of interest.

FIG. 100 shows a left block pattern combination GP3 consisting of the pixel of interest and left neighboring pixels, specifically, the pixel of interest G33, the pixel G13 two lines ahead of the pixel of interest, the pixel G22 one line and one pixel ahead of the pixel of interest, and the pixel G24 one line behind and one pixel ahead of the pixel of interest.

FIG. 10D shows a lower block pattern combination GP2 consisting of the pixel of interest and downwardly neighboring pixels, specifically, the pixel of interest G33, the pixel G35 two lines behind the pixel of interest, the pixel G24 one line behind and one pixel ahead of the pixel of interest, and the pixel G44 one line and one pixel behind the pixel of interest.

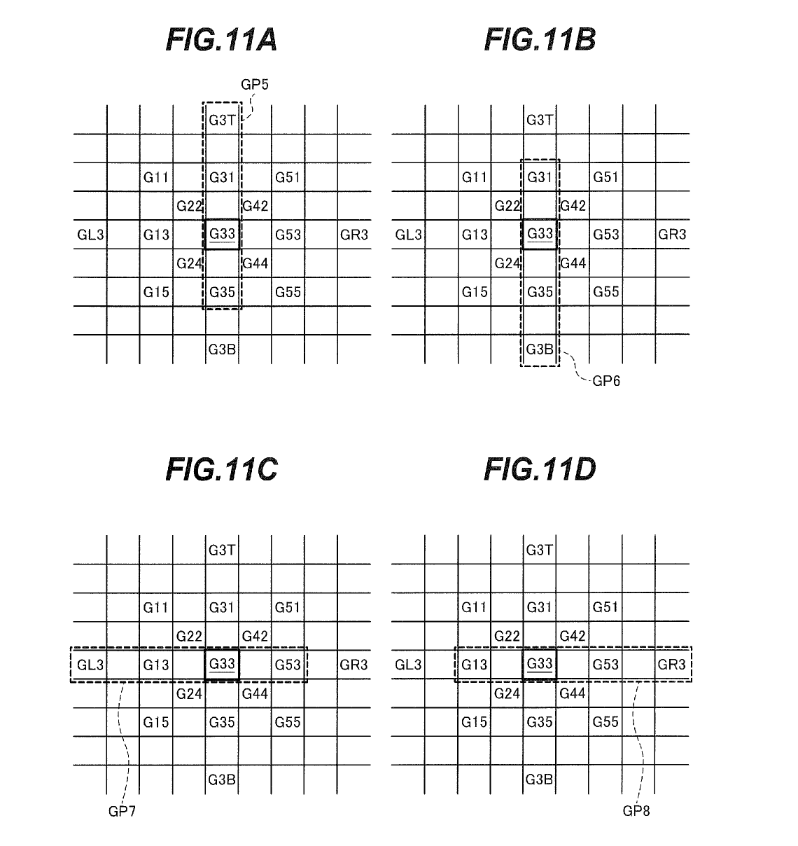

FIG. 11A shows an upper vertical line pattern combination GP5 consisting of the pixel of interest and upwardly neighboring pixels, specifically, the pixel of interest G33, the pixel G3T four lines ahead of the pixel of interest, the pixel G31 two lines ahead of the pixel of interest, and the pixel G35 two lines behind the pixel of interest.

FIG. 11B shows a lower vertical line pattern combination GP6 consisting of the pixel of interest and downwardly neighboring pixels, specifically, the pixel of interest G33, the pixel G3B four lines behind the pixel of interest, the pixel G35 two lines behind the pixel of interest, and the pixel G31 two lines ahead of the pixel of interest.

FIG. 11C shows a left horizontal line pattern combination GP7 consisting of the pixel of interest and left neighboring pixels, specifically, the pixel of interest G33, the pixel GL3 four pixels ahead of the pixel of interest, the pixel G13 two pixels ahead of the pixel of interest, and the pixel G53 two pixels behind the pixel of interest.

FIG. 11D shows a right horizontal line pattern combination GP8 consisting of the pixel of interest and right neighboring pixels, specifically, the pixel of interest G33, the pixel GR3 four pixels behind the pixel of interest, the pixel G53 two pixels behind the pixel of interest, and the pixel G13 two pixels ahead of the pixel of interest.

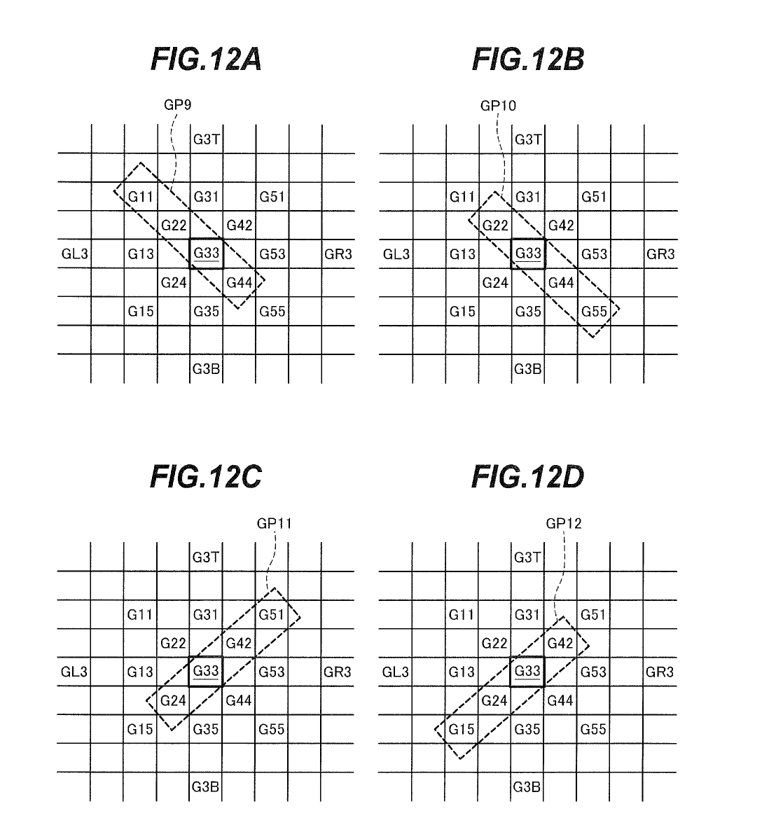

FIG. 12A shows a left diagonally upward line pattern combination GP9 consisting of the pixel of interest and upper left neighboring pixels, specifically, the pixel of interest G33, the pixel G11 two lines and two pixels ahead of the pixel of interest, the pixel G22 one line and one pixel ahead of the pixel of interest, and the pixel G44 one line and one pixel behind the pixel of interest.

FIG. 12B shows a right diagonally downward line pattern combination GP10 consisting of the pixel of interest and lower right neighboring pixels, specifically, the pixel of interest G33, the pixel G55 two lines and two pixels behind the pixel of interest, the pixel G44 one line and one pixel behind the pixel of interest, and the pixel G22 one line and one pixel ahead of the pixel of interest.

FIG. 12C shows a right diagonally upward line pattern combination GP11 consisting of the pixel of interest and upper right neighboring pixels, specifically, the pixel of interest G33, the pixel G51 two lines ahead of and two pixels behind the pixel of interest, the pixel G42 one line ahead of and one pixel behind the pixel of interest, and the pixel G24 one line behind and one pixel ahead of the pixel of interest.

FIG. 12D shows a left diagonally downward line pattern combination GP12 consisting of the pixel of interest and lower left neighboring pixels, specifically, the pixel of interest G33, the pixel G15 two lines behind and two pixels ahead of the pixel of interest, the pixel G24 one line behind and one pixel ahead of the pixel of interest, and the pixel G42 one line ahead of and one pixel behind the pixel of interest.

Using the above combinations GP1 to GP12 as first to twelfth combinations AP1 to AP12, the pixel selector 570 supplies the pixel values of their constituent pixels to the first to twelfth variation width calculators 571 to 582.

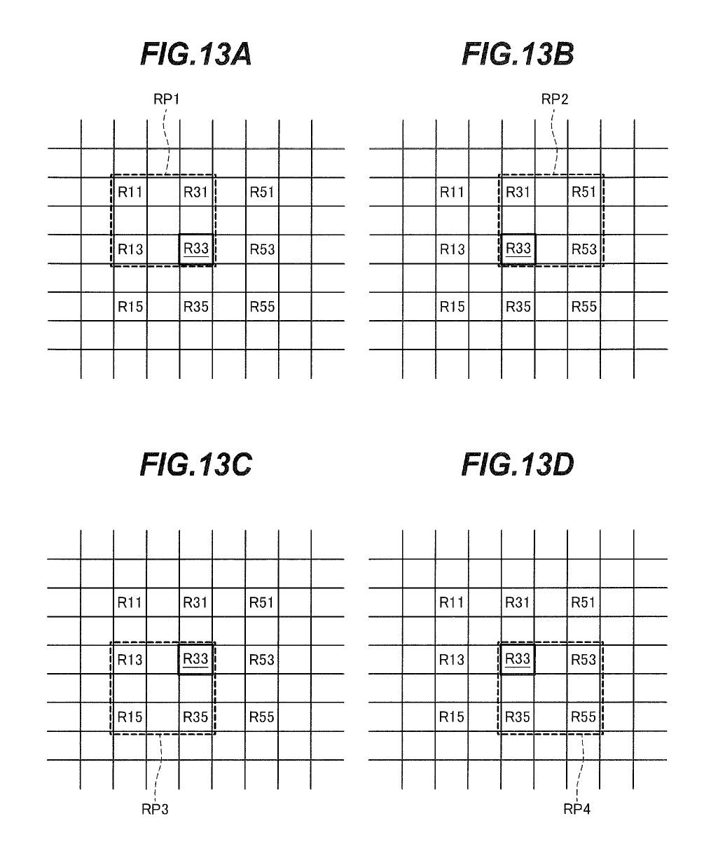

The patterns of four-pixel combinations used for performing four-pixel summation when the pixel of interest is a red pixel in the pixel spatial arrangement in FIG. 2 are shown in FIGS. 13A to 13D. In the four-pixel summation for a red pixel, the pattern with the highest correlation is selected from four combination patterns.

FIG. 13A shows an upper left block pattern combination RP1 consisting of the pixel of interest and upper left neighboring pixels, specifically, the pixel of interest R33, the pixel R31 two lines ahead of the pixel of interest, the pixel R11 two lines and two pixels ahead of the pixel of interest, and the pixel R13 two pixels ahead of the pixel of interest.

FIG. 13B shows an upper right block pattern combination RP2 consisting of the pixel of interest and upper right neighboring pixels, specifically, the pixel of interest R33, the pixel R31 two lines ahead of the pixel of interest, the pixel R51 two lines ahead of and two pixels behind the pixel of interest, and the pixel R53 two pixels behind the pixel of interest.

FIG. 13C shows a lower left block pattern combination RP3 consisting of the pixel of interest and lower left neighboring pixels, specifically, the pixel of interest R33, the pixel R13 two pixels ahead of the pixel of interest, the pixel R35 two lines behind the pixel of interest, and the pixel R15 two lines behind and two pixels ahead of the pixel of interest.

FIG. 13D shows a lower right block pattern combination RP4 consisting of the pixel of interest and lower right neighboring pixels, specifically, the pixel of interest R33, the pixel R53 two pixels behind the pixel of interest, the pixel R35 two lines behind the pixel of interest, and the pixel R55 two lines and two pixels behind the pixel of interest.

Using the above combinations RP1 to RP4 as the first to fourth combinations AP1 to AP4, the pixel selector 570 supplies the pixel values of their constituent pixels to the first to fourth variation width calculators 571 to 574.

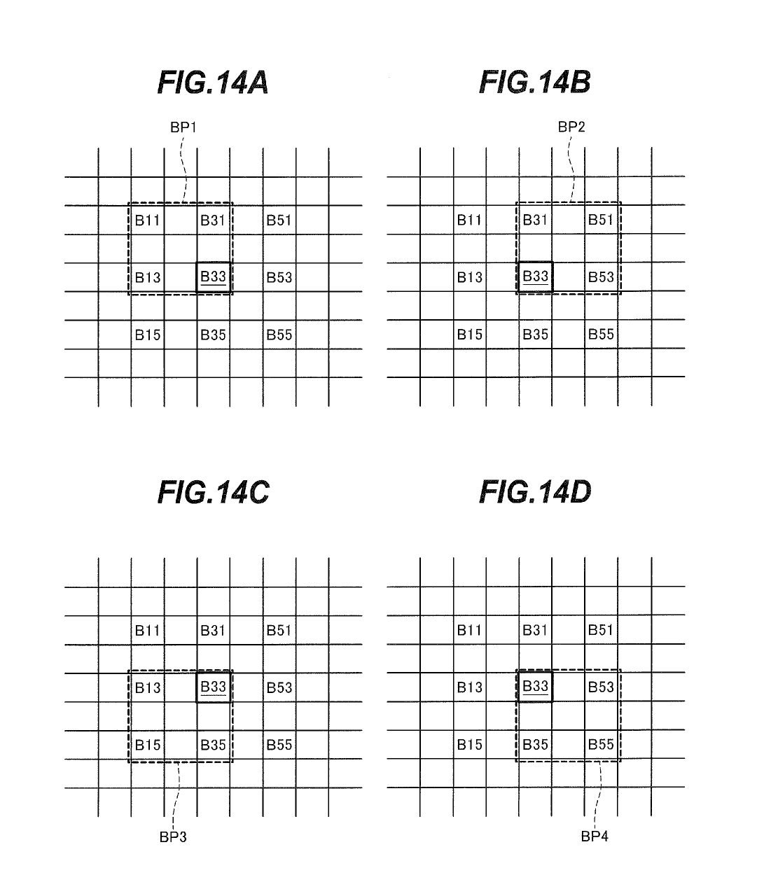

The patterns of four-pixel combinations used for performing four-pixel summation when the pixel of interest is a blue pixel in the pixel spatial arrangement in FIG. 2 are shown in FIGS. 14A to 14D. In the four-pixel summation for a blue pixel, the pattern with the highest correlation is selected from four combination patterns.

FIG. 14A shows an upper left block pattern combination BP1 consisting of the pixel of interest and upper left neighboring pixels, specifically, the pixel of interest B33, the pixel B31 two lines ahead of the pixel of interest, the pixel B11 two lines and two pixels ahead of the pixel of interest, and the pixel B13 two pixels ahead of the pixel of interest.

FIG. 14B shows an upper right block pattern combination BP2 consisting of the pixel of interest and upper right neighboring pixels, specifically, the pixel of interest B33, the pixel B31 two lines ahead of the pixel of interest, the pixel B51 two lines ahead of and two pixels behind the pixel of interest, and the pixel B53 two pixels behind the pixel of interest.

FIG. 14C shows a lower left block pattern combination BP3 consisting of the pixel of interest and lower left neighboring pixels, specifically, the pixel of interest B33, the pixel B13 two pixels ahead of the pixel of interest, the pixel B35 two lines behind the pixel of interest, and the pixel B15 two lines behind and two pixels ahead of the pixel of interest.

FIG. 14D shows a lower right block pattern combination BP4 consisting of the pixel of interest and lower right neighboring pixels, specifically, the pixel of interest B33, the pixel B53 two pixels behind the pixel of interest, the pixel B35 two lines behind the pixel of interest, and the pixel B55 two lines and two pixels behind the pixel of interest.

Using the above combinations BP1 to BP4 as the first to fourth combinations AP1 to AP4, the pixel selector 570 supplies the pixel values of their constituent pixels to the first to fourth variation width calculators 571 to 574.

As described above, the combinations of pixels prepared when the pixel of interest is a green pixel are classified as block (lozenge) patterns and line (band) patterns depending on the shape of the area forming the combination. The block pattern combinations are classified according to whether the center of the area is located upward, right, left, or downward of the pixel of interest. The line pattern combinations are classified according to whether the center of the area is located upward, downward, left, right, left diagonally upward, right diagonally downward, right diagonally upward, or left diagonally downward with respect to the pixel of interest.

Accordingly, the pixel summing pattern code PAT indicates which of the patterns shown in FIGS. 10A to 10D, 11A to 11D, and 12A to 12D the selected combination has, that is, whether the area consisting of the pixel of interest and its neighboring pixels is of a block (lozenge) pattern or a line (band) pattern, and whether the relative position or direction of the center of the area with respect to the specified pixel is upward, right, left, or downward for a block pattern, and upward, right, left, downward, left diagonally upward, right diagonally upward, left diagonally downward, or right diagonally downward for a line pattern.

The combinations of pixels prepared when the pixel of interest is a red pixel or a blue pixel all have block pattern areas, so that they are classified according to whether their centers are located left diagonally upward, right diagonally upward, left diagonally downward, or right diagonally downward with respect to the pixel of interest.

Accordingly, the pixel summing pattern code PAT indicates which of the patterns shown in FIGS. 13A to 13D or FIGS. 14A to 14D the selected combination has, that is, whether the relative position or direction of the center of the area consisting of the pixel of interest and its neighboring pixels with respect to the specified pixel is left diagonally upward, right diagonally upward, left diagonally downward, or right diagonally downward.

The present invention is not limited to the above example. The shape of the area consisting of the pixel of interest and its neighboring pixels and the direction of the center of the area in relation to the pixel of interest may differ from the shapes and directions shown in FIGS. 10A to 10D, 11A to 11D, 12A to 12D, 13A to 13D, and 14A to 14D. In any case, the pixel summing pattern code PAT indicates the relative position or direction of the area consisting of the pixel of interest and its neighboring pixels with respect to the pixel of interest.

The first to twelfth variation width calculators 571 to 582 respectively calculate the differences between the maximum pixel value and the minimum pixel value in the input first to twelfth combinations AP1 to AP12 as their variation widths.

More specifically, each of the first to twelfth variation width calculators 571 to 582 compares the pixel values of the four input pixels and determines the maximum pixel value and minimum pixel value. Then it calculates the difference between the maximum pixel value and minimum pixel value and supplies the result as the variation width of the combination (pixel area) to the minimum value calculation unit 585.

When the pixel of interest is a green pixel:

the variation width calculator 571 calculates the variation width of the combination with the upward block pattern GP1 input as the first combination AP1 and outputs the result as a first variation width WP1;

the variation width calculator 572 calculates the variation width of the combination with the right block pattern GP2 input as the second combination AP2 and outputs the result as a second variation width WP2;

the variation width calculator 573 calculates the variation width of the combination with the left block pattern GP3 input as the third combination AP3 and outputs the result as a third variation width WP3;

the variation width calculator 574 calculates the variation width of the combination with the downward block pattern GP4 input as the fourth combination AP4 and outputs a fourth variation width WP4;

the variation width calculator 575 calculates the variation width of the combination with the upward vertical line pattern GP5 input as the fifth combination AP5 and outputs the result as the result as a fifth variation width WP5;

the variation width calculator 576 calculates the variation width of the combination with the downward vertical line pattern GP6 input as the sixth combination AP6 and outputs the result as a sixth variation width WP6;

the variation width calculator 577 calculates the variation width of the combination with the left horizontal line pattern G7 input as the seventh combination AP7 and outputs the result as a seventh variation width WP7;

the variation width calculator 578 calculates the variation width of the combination with the right horizontal line pattern GP8 input as the eighth combination AP8 and outputs the result as an eighth variation width WP8;

the variation width calculator 579 calculates the variation width of the combination with the left diagonally upward line pattern GP9 input as the ninth combination AP9 and outputs the result as a ninth variation width WP9;

the variation width calculator 580 calculates the variation width of the combination with the right diagonally downward line pattern GP10 input as the tenth combination AP10 and outputs the result as a tenth variation width WP10;

the variation width calculator 581 calculates the variation width of the combination with the right diagonally upward line pattern GP11 input as the eleventh combination AP11 and outputs the result as an eleventh variation width WP11; and

the variation width calculator 582 calculates the variation width of the combination with the left diagonally downward line pattern GP12 input as the twelfth combination AP12 and outputs the result as a twelfth variation width WP12.

When the pixel of interest is a red pixel or a blue pixel:

the variation width calculator 571 calculates the variation width of the combination with the left upward block pattern RP1 or BP1 input as the first combination AP1 and outputs the result as a first variation width WP1;

the variation width calculator 572 calculates the variation width of the combination with the right upward block pattern RP2 or BP2 input as the second combination AP2 and outputs the result as a second variation width WP2;

the variation width calculator 573 calculates the variation width of the combination with the left downward block pattern RP3 or BP3 input as the third combination AP3 and outputs the result as a third variation width WP3; and

the variation width calculator 574 calculates the variation width of the combination with the right downward block pattern RP4 or BP4 input as the fourth combination AP4 and outputs the result as a fourth variation width WP4.

The variation width calculators 575 to 582 do not perform variation width calculations.

The operation of the minimum value calculation unit 585 when the pixel of interest is a green pixel will now be described.

The minimum value calculation unit 585 receives the first to twelfth variation widths WP1 to WP12 output from the variation width calculators 571 to 582; then, from among the variation widths, the minimum value calculation unit 585 selects the minimum variation width and sends a notification (a pixel summing pattern code) PAT indicating the combination pattern (summation pixel pattern) with the minimum variation width to the pixel designation unit 587 and the signal combiner 24.

The pixel designation unit 587 supplies the information (summation pixel position information) POS indicating the positions of the pixels constituting the combination identified by the pixel summing pattern code PAT received from the minimum value calculation unit 585, to the selective summation unit 23.

When the variation width of the upward block pattern GP1 is minimum, the position information POS of the pixels G31, G22, G42, and G33 is supplied to the selective summation unit 23.

When the variation width of the right block pattern GP2 is minimum, the position information POS of the pixels G42, G33, G53, and G44 is supplied to the selective summation unit 23.

When the variation width of the left block pattern GP3 is minimum, the position information POS of the pixels G22, G13, G33, and G24 is supplied to the selective summation unit 23.

When the variation width of the downward block pattern GP4 is minimum, the position information POS of the pixels G33, G24, G44, and G35 is supplied to the selective summation unit 23.

When the variation width of the upward vertical line pattern GP5 is minimum, the position information POS of the pixels G3T, G31, G33, and G35 is supplied to the selective summation unit 23.

When the variation width of the downward vertical line pattern GP6 is minimum, the position information POS of the pixels G31, G33, G35, and G3B is supplied to the selective summation unit 23.

When the variation width of the left horizontal line pattern GP7 is minimum, the position information POS of the pixels GL3, G13, G33, and G53 is supplied to the selective summation unit 23.

When the variation width of the right horizontal line pattern GP8 is minimum, the position information POS of the pixels G13, G33, G53, and GR3 is supplied to the selective summation unit 23.

When the variation width of the left diagonally upward line pattern GP9 is minimum, the position information POS of the pixels G11, G22, G33, and G44 is supplied to the selective summation unit 23.

When the variation width of the right diagonally downward line pattern GP10 is minimum, the position information POS of the pixels G22, G33, G44, and G55 is supplied to the selective summation unit 23.

When the variation width of the right diagonally upward line pattern GP11 is minimum, the position information POS of the pixels G51, G42, G33, and G24 is supplied to the selective summation unit 23.

When the variation width of the left diagonally downward line pattern GP12 is minimum, the position information POS of the pixels G42, G33, G24, and G15 is supplied to the selective summation unit 23.

In this process, the correlated area detection unit 590 configured by the minimum value calculation unit 585 and the pixel designation unit 587 receives the first to twelfth variation widths WP1 to WP12 output from the variation width calculators 571 to 582, determines the pixel area formed by the pixels constituting the combination with the minimum variation width to be the pixel area with the highest correlation, supplies the information (summation pixel information) POS indicating the position of that area (the positions of the pixels constituting the area) to the selective summation unit 23, and also supplies the information indicating the pattern (type) of the combination with the minimum variation width (information indicating which of the patterns shown in FIGS. 10A to 10D, 11A to 11B, and 12A to 12D is the pattern of the combination with the minimum variation width) as a pixel summing pattern code PAT to the signal combiner 24.

The operation of the minimum value calculation unit 585 when the pixel of interest is a red pixel will now be described.

The minimum value calculation unit 585 receives the first to fourth variation widths WP1 to WP4 output from the variation width calculators 571 to 574; then, from among the variation widths, it selects the minimum variation width and sends a notification (a pixel summing pattern code) PAT indicating the combination pattern (summation pixel pattern) with the minimum variation width to the pixel designation unit 587 and the signal combiner 24.

The pixel designation unit 587 supplies the information (summation pixel position information) POS indicating the positions of the pixels constituting the combination identified by the pixel summing pattern code PAT received from the minimum value calculation unit 585, to the selective summation unit 23.

When the variation width of the left upward block pattern RP1 is minimum, the position information POS of the pixels R11, R31, R13, and R33 is supplied to the selective summation unit 23.

When the variation width of the right upward block pattern RP2 is minimum, the position information POS of the pixels R31, R51, R33, and G53 is supplied to the selective summation unit 23.

When the variation width of the left downward block pattern RP3 is minimum, the position information POS of the pixels R13, R33, R15, and R35 is supplied to the selective summation unit 23.

When the variation width of the right downward block pattern RP4 is minimum, the position information POS of the pixels R33, R53, R35, and R55 is supplied to the selective summation unit 23.

In this process, the correlated area detection unit 590 receives the first to fourth variation widths WP1 to WP4 output from the variation width calculators 571 to 574, determines the pixel area formed by the pixels constituting the combination with the minimum variation width to be the pixel area with the highest correlation, supplies the information (summation pixel information) POS indicating the position of that area (the positions of the pixels constituting the area) to the selective summation unit 23, and also supplies the information indicating the pattern (type) of the combination with the minimum variation width (information indicating which of the patterns shown in FIGS. 13A to 13D is the pattern of the combination with the minimum variation width) as a pixel summing pattern code PAT to the signal combiner 24.

The operation of the minimum value calculation unit 585 when the pixel of interest is a blue pixel will now be described.

The minimum value calculation unit 585 receives the first to fourth variation widths WP1 to WP4 output from the variation width calculators 571 to 574, then, from among the variation widths, it selects the minimum variation width and sends a notification (a pixel summing pattern code) PAT indicating the combination pattern (summation pixel pattern) with the minimum variation width to the pixel designation unit 587 and the signal combiner 24.

The pixel designation unit 587 supplies the information (summation pixel position information) POS indicating the positions of the pixels constituting the combination identified by the pixel summing pattern code PAT received from the minimum value calculation unit 585, to the selective summation unit 23.

When the variation width of the left upward block pattern BP1 is minimum, the position information POS of the pixels B11, B31, B13, and B33 is supplied to the selective summation unit 23.

When the variation width of the right upward block pattern BP2 is minimum, the position information POS of the pixels B31, B51, B33, and B53 is supplied to the selective summation unit 23.

When the variation width of the left downward block pattern BP3 is minimum, the position information POS of the pixels B13, B33, B15, and B35 is supplied to the selective summation unit 23.

When the variation width of the right downward block pattern BP4 is minimum, the position information POS of the pixels B33, B53, B35, and B55 is supplied to the selective summation unit 23.

In this process, the correlated area detection unit 590 receives the first to fourth variation widths WP1 to WP4 output from the variation width calculators 571 to 574, determines the pixel area formed by the pixels constituting the combination with the minimum variation width to be the pixel area with the highest correlation, supplies the information (summation pixel information) POS indicating the position of that area (the positions of the pixels constituting the area) to the selective summation unit 23, and also supplies the information indicating the pattern (type) of the combination with the minimum variation width (information indicating which of the patterns shown in FIGS. 14A to 14D is the pattern of the combination with the minimum variation width) as a pixel summing pattern code PAT to the signal combiner 24.

In the configuration described above, the combination with the highest correlation is selected from among twelve combinations for green pixels and four combinations each for red and blue pixels, so that pixels highly correlated with the pixel of interest can properly selected for use in the pixel summation; this can reduce the loss of image resolution after the pixel summation.

In the example described above, the pixel selector 570, the variation width calculators 571 to 582, and the minimum value calculation unit 585 operate differently when the pixel of interest is a green pixel from when the pixel of interest is a red pixel or a blue pixel, or some of the output pixels are not used when the pixel of interest is a red pixel or a blue pixel. As another alternative, a pixel selector, variation width calculators, and a minimum value calculation unit used when the pixel of interest is a red pixel or a blue pixel may be provided separately from a pixel selector, variation width calculators, and a minimum value calculation unit used when the pixel of interest is a green pixel.

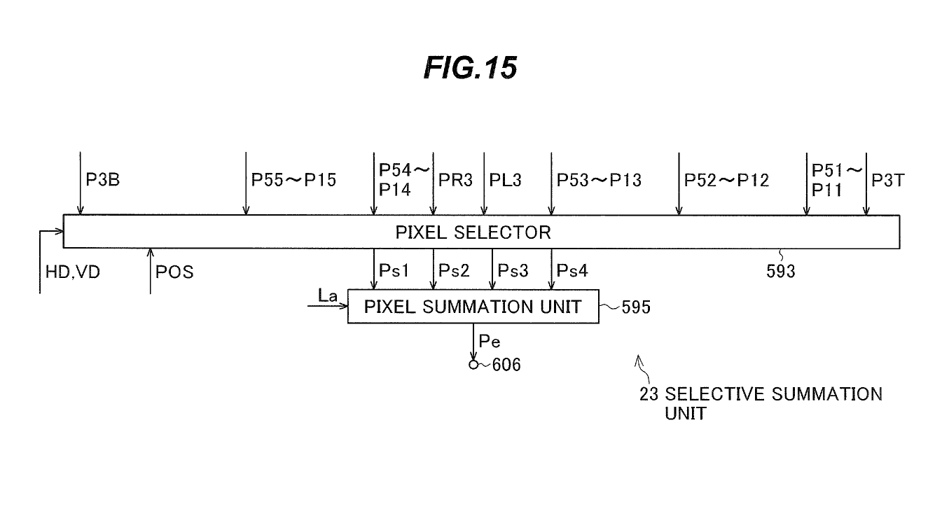

Next, the selective summation unit 23 will be described. As shown in FIG. 15, the selective summation unit 23 includes a pixel selector 593 and a pixel summation unit 595.

The pixel signals P55 to P11, P3B, PR3, PL3, and P3T extracted by the pixel extractor 21 are supplied to the pixel selector 593.

The summation pixel position information POS reported from the pixel designation unit 587 in the area selector 22 and the horizontal synchronization signal HD and the vertical synchronization signal VD output from the synchronization signal generator 11 in FIG. 1 are also supplied to the pixel selector 593.

From the horizontal synchronization signal HD and the vertical synchronization signal VD, the pixel selector 593 determines the position of the pixel of interest P33 and identifies the position of the pixel of interest on its color filter array.

The pixel selector 593 also determines whether the pixel of interest is a red pixel, a green pixel, or a blue pixel. Then, from the summation position information POS received from the pixel designation unit 587, it identifies the pixel positions of the four pixels constituting the selected area.

The pixel selector 593 supplies the pixel values Ps1 to Ps4 of the four pixels at the pixel positions indicated by the summation pixel position information POS to the pixel summation unit 595.

A signal indicating the sensitivity multiplier La (La equals 1 to 4) output from the control unit 12 is supplied to the pixel summation unit 595.

The pixel summation unit 595 sums the pixel values of the four pixels supplied from the pixel selector 593 and supplies the resulting sum as an intra-plane sensitized signal Pe to the signal combiner 24 via an output terminal 606. In the calculation of the sum, a summation coefficient (weighting coefficient) is multiplied such that the resulting sum has the sensitivity that is boosted by the prescribed factor La with respect to the pixel values before summation.

For example, when the pixel values of the four pixels are Ps1, Ps2, Ps3, and Ps4 and the sensitivity multiplier is La, (the value of) the intra-plane sensitized signal Pe is obtained from the calculation expressed by the following equation:

Pe=(Ps1+Ps2+Ps3+Ps4)×La/4

In the following description, (the value of) the intra-plane sensitized signal of a green pixel is denoted Ge, (the value of) the intra-plane sensitized signal of a red pixel is denoted Re, and (the value of) the intra-plane sensitized signal of a blue pixel is denoted Be.

The operation when the pixel of interest is a green pixel will now be described.

When the combination with the upward block pattern GP1 is selected as the first combination AP1, the pixel summation unit 595 performs the following calculation.

Ge=(G31+G22+G42+G33)×La/4

When the combination with the right block pattern GP2 is selected as the second combination AP2, the pixel summation unit 595 performs the following calculation.

Ge=(G42+G33+G53+G44)×La/4

When the combination with the left block pattern GP3 is selected as the third combination AP3, the pixel summation unit 595 performs the following calculation.

Ge=(G22+G13+G33+G24)×La/4

When the combination with the downward block pattern GP4 is selected as the fourth combination AP4, the pixel summation unit 595 performs the following calculation.

Ge=(G33+G24+G44+G35)×La/4

When the combination with the upward vertical line pattern GP5 is selected as the fifth combination AP5, the pixel summation unit 595 performs the following calculation.

Ge=(G3T+G31+G33+G35)×La/4

When the combination with the downward vertical line pattern GP6 is selected as the sixth combination AP6, the pixel summation unit 595 performs the following calculation.

Ge=(G31+G33+G35+G3B)×La/4

When the combination with the left horizontal line pattern GP7 is selected as the seventh combination AP7, the pixel summation unit 595 performs the following calculation.

Ge=(GL3+G13+G33+G53)×La/4

When the combination with the right horizontal line pattern GP8 is selected as the eighth combination AP8, the pixel summation unit 595 performs the following calculation.

Ge=(G13+G33+G53+GR3)×La/4

When the combination with the left diagonally upward block pattern GP9 is selected as the ninth combination AP9, the pixel summation unit 595 performs the following calculation.

Ge=(G11+G22+G33+G44)×La/4

When the combination with the right diagonally downward line pattern GP10 is selected as the tenth combination AP10, the pixel summation unit 595 performs the following calculation.

Ge=(G22+G33+G44+G55)×La/4

When the combination with the right diagonally upward block pattern GP11 is selected as the eleventh combination AP11, the pixel summation unit 595 performs the following calculation.

Ge=(G51+G42+G33+G24)×La/4

When the combination with the left diagonally downward block pattern GP12 is selected as the twelfth combination AP12, the pixel summation unit 595 performs the following calculation.

Ge=(G42+G33+G24+G15)×La/4

The operation when the pixel of interest is a red pixel will now be described.

When the combination with the left upward block pattern RP1 is selected as the first combination AP1, the pixel summation unit 595 performs the following calculation.

Re=(R11+R31+R13+R33)×La/4

When the combination with the right upward block pattern RP2 is selected as the second combination AP2, the pixel summation unit 595 performs the following calculation.

Re=(R31+R51+R33+R53)×La/4

When the combination with the left downward block pattern RP3 is selected as the third combination AP3, the pixel summation unit 595 performs the following calculation.

Re=(R13+R33+R15+R35)×La/4

When the combination with the right downward block pattern RP4 is selected as the fourth combination AP4, the pixel summation unit 595 performs the following calculation.

Re=(R33+R53+R35+R55)×La/4

The operation when the pixel of interest is a blue pixel will now be described.

When the combination with the left upward block pattern BP1 is selected as the first combination AP1, the pixel summation unit 595 performs the following calculation.

Be=(B11+B31+B13+B33)×La/4

When the combination with the right upward block pattern BP2 is selected as the second combination AP2, the pixel summation unit 595 performs the following calculation.

Be=(B31+B51+B33+B53)×La/4

When the combination with the left downward block pattern BP3 is selected as the third combination AP3, the pixel summation unit 595 performs the following calculation.

Be=(B13+B33+B15+B35)×La/4

When the combination with the right downward block pattern BP4 is selected as the fourth combination AP4, the pixel summation unit 595 performs the following calculation.

Be=(B33+B53+B35+B55)×La/4

The above example is configured in such a way that for green pixels, pixel summation is performed by use of combination patterns, such as vertical, horizontal, and diagonal line patterns and block patterns, designed for images including a high-resolution subject, so that highly correlated pixels can be summed. This has the effect of preventing blurring of high-resolution portions, even when pixel summation is performed on scenes with a subject including fine patterns or fine irregularities.

Although only block pattern combinations are used for red pixels and blue pixels in the above example, vertical, horizontal, and diagonal line patterns may also be used as in the case of green pixels when the correlations are determined.

For red pixels and blue pixels, the combination patterns should be determined in overall consideration of factors such as increased circuit size, the greater likelihood of erroneous correlation determination due to the greater distances between the summed pixels, as compared with green pixels, and the fact that human vision is less sensitive to color changes than to luminance changes.

In the above example, three neighboring pixels are summed with the pixel of interest, but combinations that sum more neighboring pixels may be used. Higher sensitivity can then be achieved.

For green pixels, it is not necessary to use all twelve combination patterns; a subset of these patterns may be used. For example, only the four patterns shown in FIGS. 10A to 10D may be used, only the four patterns shown in FIGS. 11A to 11D may be used, or only the four patterns shown in FIGS. 12A to 12D may be used.

Alternatively, only one combination pattern may be used for intra-plane pixel summation of red pixels and blue pixels in a Bayer array. In this case, in the inter-plane pixel summation described later, it is not necessary to determine whether the pixel summing pattern codes match; only a pixel value correlation determination need be made to select the summation pixel in each neighboring frame.

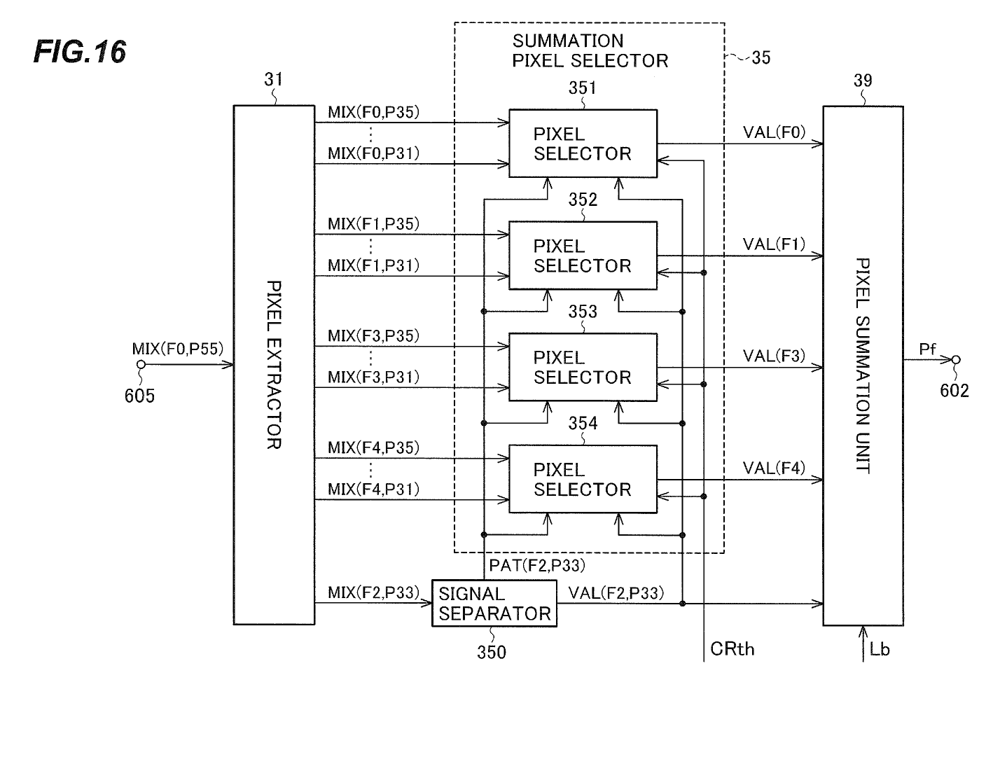

Next, the operation of the inter-plane pixel summation unit 30 will be described with reference to FIG. 16.

The inter-plane pixel summation unit 30 includes a pixel extractor 31, a signal separator 350, a summation pixel selector 35, and a pixel summation unit 39. The summation pixel selector 35 has first to fourth pixel selectors 351 to 354.

Composite signals MIX of (pertaining to) individual pixels of the consecutive frames are sequentially output from the output terminal 604 of the intra-plane pixel summation unit 20, and sequentially input through an input terminal 605 of the inter-plane pixel summation unit 30 to the pixel extractor 31.

The pixel extractor 31 delays the composite signal MIX input to the input terminal 605 by mutually different times to simultaneously extract the composite signals MIX of a plurality of mutually neighboring pixels in the plurality of frames. In this case, the frame positioned at the center of the plurality of frames is treated as the frame of interest, a pixel in the frame of interest is extracted as the pixel of interest, and a pixel positioned identically to the pixel of interest and one or more pixels in the neighborhood of the identically positioned pixel are extracted from each of the other frames. Accordingly, the extraction process can be described as a process for simultaneously extracting the composite signal MIX of the pixel of interest in the frame of interest and the composite signals MIX of one or more pixels (reference pixels) in each of frames (reference frames) positioned near the frame of interest. As the frames and the pixels that are extracted change, it can also be said to be a process for sequentially specifying consecutive frames as the frame of interest, sequentially specifying pixels in the frame of interest as the pixel of interest, and simultaneously extracting the composite signal MIX of the pixel of interest in the frame of interest and the composite signals MIX of reference pixels in frames positioned near the frame of interest.

The configuration of the pixel extractor 31, and the operation when a green pixel is specified as the pixel of interest will be described first, and subsequently the operation when a red pixel or a blue pixel are specified as the pixel of interest will be described.

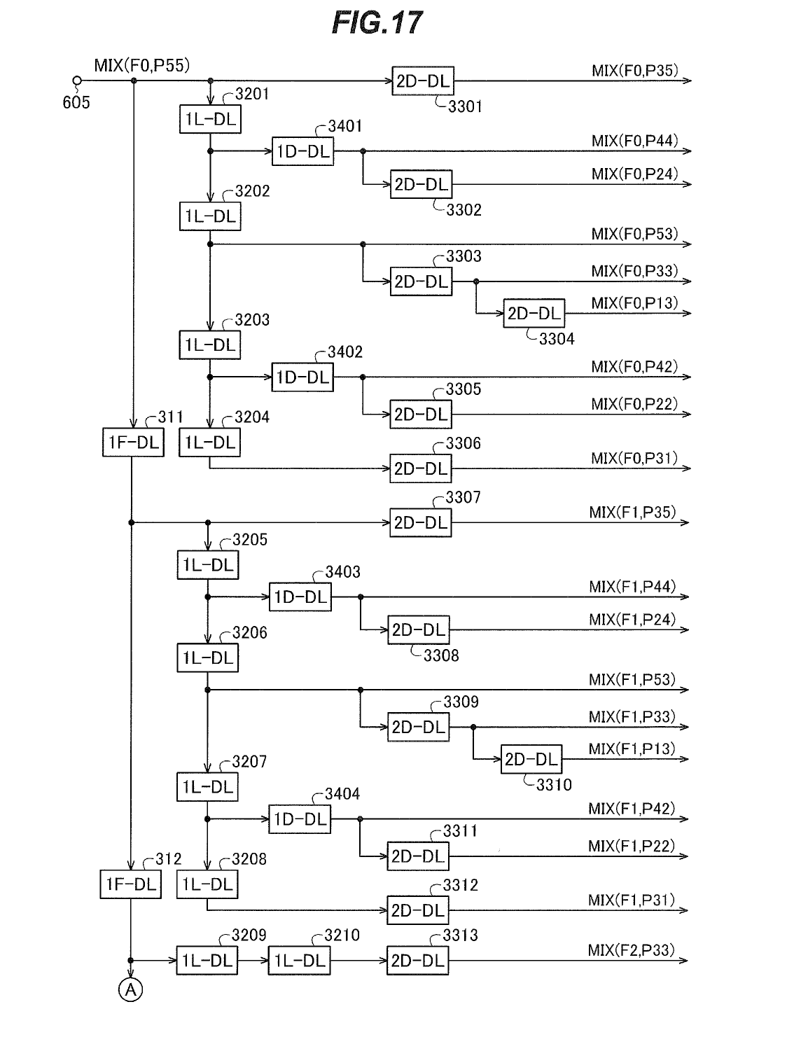

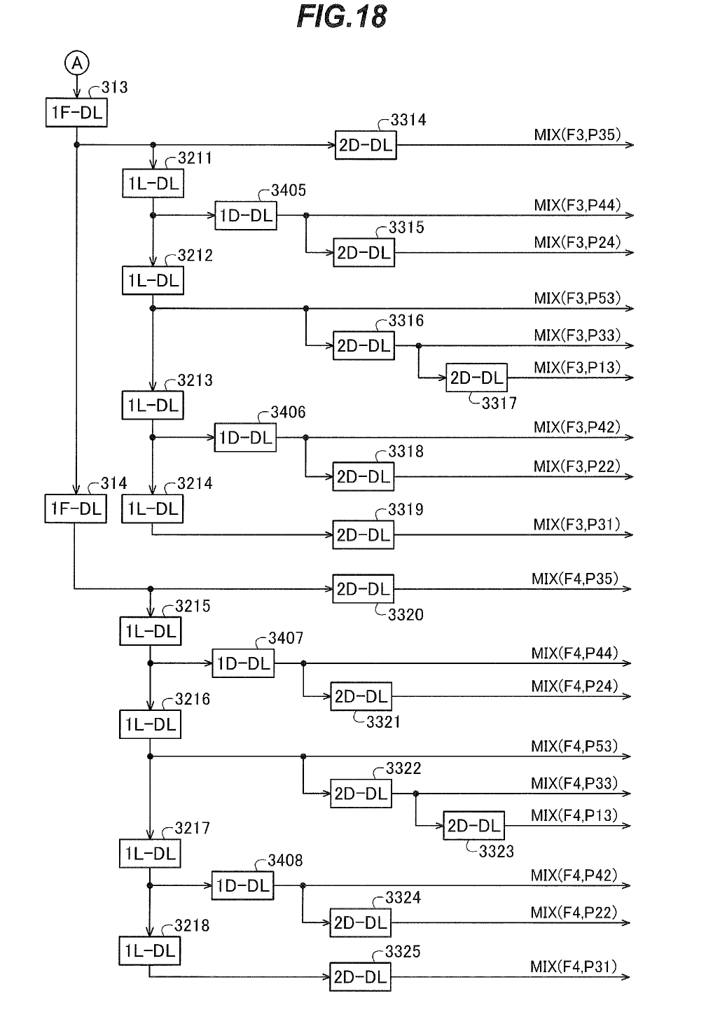

The pixel extractor 31 is configured, for example, as shown in FIGS. 17 and 18.

In FIGS. 17 and 18, 1F-DL indicates a one-frame delay unit, 1L-DL indicates a one-line delay unit, 1D-DL indicates a one-pixel delay unit, and 2D-DL indicates a two-pixel delay unit.

The pixel extractor 31 is configured with one-frame delay units 311 to 314, one-line delay units 3201 to 3218, and one-pixel delay units 3401 to 3408 that are interconnected as shown in the drawings. It delays the composite signal MIX input to the input terminal 605 by various different times, and thereby outputs composite signals for pixels in mutually neighboring frames.

Among the output signals, the signal output from delay unit 3313 is used as the composite signal of the pixel of interest P33 (FIG. 2) in the frame of interest F2. When the signal from delay unit 3313 is specified as the pixel of interest P33 (FIG. 2) in the frame of interest F2, the composite signal MIX input to the input terminal 605 at this time is the composite signal MIX of the pixel P55 (FIG. 2) in a frame F0, two frames behind the frame F2, and the composite signal MIX of the pixel of interest in the frame of interest, and the composite signals MIX of the pixels P33 positioned identically to the pixel of interest and the pixels P31, P22, P42, P13, P53, P24, P44, and P35 in the neighborhoods of the individual identically positioned pixels in the neighboring frames F0, F1, F3, and F4 are simultaneously output.

The frames F1, F3, and F4 respectively indicate the frame one frame behind (the next frame) the frame of interest F2, the frame one frame ahead of (previous frame) the frame of interest F2, and two frames ahead of the frame of interest F2.

The composite signal MIX of the pixel P55 in the frame F0 will also be denoted MIX(F0, P55) for distinction. The composite signals MIX of other pixels will be similarly denoted. The intra-plane sensitized signal VAL, the summation pixel pattern symbol PAT, and the three-dimensionally sensitized signal Pf will also be similarly denoted. When the distinction is not necessary, these signals and patterns will simply be denoted MIX, VAL, PAT, and Pf.

The processing by each delay unit in the pixel extractor 31 will now be described.

The composite signal MIX(F0, P55) input to the input terminal 605 is sequentially delayed in the one-frame delay units 311 to 314 to generate signals MIX(F1, P55), MIX(F2, P55), MIX(F3, P55), and MIX(F4, P55).

The signal MIX(F0, P55) input to the input terminal 605 is delayed by two-pixel delay unit 3301 to generate signal MIX(F0, P35). It is also delayed by one-line delay units 3201 and 3401 to generate signal MIX(F0, P44), and further delayed by two-pixel delay unit 3302 to generate signal MIX (F0, P24).

The output from one-line delay unit 3201 is delayed by one-line delay unit 3202 to generate signal MIX(F0, P53), also delayed by two-pixel delay unit 3303 to generate signal MIX(F0, P33), and further delayed by two-pixel delay unit 3304 to generate signal MIX(F0, P13).

The output from one-line delay unit 3202 is delayed by one-line delay units 3203 and 3402 to generate signal MIX(F0, P42), and also delayed by two-pixel delay unit 3305 to generate signal MIX(F0, P22).

The output from one-line delay unit 3203 is delayed by one-line delay unit 3204 and two-pixel delay unit 3306 to generate signal MIX(F0, P31).

The signal MIX(F1, P55) output from one-frame delay unit 311 is delayed by two-pixel delay unit 3307 to generate signal MIX(F1, P35). It is also delayed by one-line delay unit 3205 and one-pixel delay unit 3403 to generate signal MIX(F1, P44), and further delayed by two-pixel delay unit 3308 to generate signal MIX(F1, P24).

The output from one-line delay unit 3205 is delayed by one-line delay unit 3206 to generate signal MIX(F1, P53), also delayed by two-pixel delay unit 3309 to generate signal MIX(F1, P33), and further delayed by two-pixel delay unit 3310 to generate signal MIX(F1, P13).

The output from one-line delay unit 3206 is delayed by one-line delay unit 3207 and one-pixel delay unit 3404 to generate signal MIX(F1, P42), and also delayed by two-pixel delay unit 3311 to generate signal MIX(F1, P22).

The output from one-line delay unit 3207 is delayed by one-line delay unit 3208 and two-pixel delay unit 3312 to generate signal MIX(F1, P31).

The signal MIX(F2, P55) output from one-frame delay unit 312 is delayed by one-line delay unit 3209, one-line delay unit 3210, and two-pixel delay unit 3313 to generate signal MIX(F2, P33).

The signal MIX(F3, P55) output from one-frame delay unit 313 is delayed by two-pixel delay unit 3314 to generate signal MIX(F3, P35). It is also delayed by one-line delay unit 3211 and one-pixel delay unit 3405 to generate signal MIX(F3, P44), and further delayed by two-pixel delay unit 3315 to generate signal MIX(F3, P24).

The output from one-line delay unit 3211 is delayed by one-line delay unit 3212 to generate signal MIX(F3, P53), also delayed by two-pixel delay unit 3316 to generate signal MIX(F3, P33), and further delayed by two-pixel delay unit 3317 to generate signal MIX(F3, P13).

The output from one-line delay unit 3212 is delayed by one-line delay unit 3213 and one-pixel delay unit 3406 to generate signal MIX(F3, P42), and also delayed by two-pixel delay unit 3318 to generate signal MIX(F3, P22).

The output from one-line delay unit 3213 is delayed by one-line delay unit 3214 and two-pixel delay unit 3319 to generate signal MIX(F3, P31).

The signal MIX(F4, P55) output from one-frame delay unit 314 is delayed by two-pixel delay unit 3320 to generate signal MIX(F4, P35). It is also delayed by one-line delay unit 3215 and one-pixel delay unit 3407 to generate signal MIX(F4, P44), and further delayed by two-pixel delay unit 3321 to generate signal MIX(F4, P24).

The output from one-line delay unit 3215 is delayed by one-line delay unit 3216 to generate signal MIX(F4, P53), also delayed by two-pixel delay unit 3324 to generate signal MIX(F4, P33), and further delayed by two-pixel delay unit 3317 to generate signal MIX(F4, P13).

The output from one-line delay unit 3216 is delayed by one-line delay unit 3217 and one-pixel delay unit 3408 to generate signal MIX(F4, P42), and also delayed by two-pixel delay unit 3324 to generate signal MIX(F4, P22).

The output from one-line delay unit 3217 is delayed by one-line delay unit 3218 and two-pixel delay unit 3325 to generate signal MIX(F4, P31).

Among the signals MIX(F0, P35) to MIX(F4, P31) generated in this way, the signals MIX(F0, P35) to MIX(F0, P31) are supplied to the first pixel selector 351, the signals MIX(F1, P35) to MIX(F1, P31) are supplied to the second pixel selector 352, the signals MIX(F3, P35) to MIX(F3, P31) are supplied to the third pixel selector 353, and the signals MIX(F4, P35) to MIX(F4, P31) are supplied to the fourth pixel selector 354.

When the processing is performed with a red pixel or a blue pixel as the pixel of interest, the pixel extractor 31 disables those parts of the circuits shown in FIGS. 17 and 18 that output the signals for the four pixels P44, P24, P42, and P22 in each frame, that is, the signals MIX(F0, P44), MIX (F0, P24), MIX (F0, P42), MIX (F0, P22), MIX(F1, P44), MIX(F1, P24), MIX(F1, P42), MIX(F1, P22), MIX(F3, P44), MIX(F3, P24), MIX(F3, P42), MIX(F3, P22), MIX(F4, P44), MIX(F4, P24), MIX(F4, P42), and MIX(F4, P22), or does not use these outputs.

Instead of having the pixel extractor 31 operate differently when a red pixel or a blue pixel is specified as the pixel of interest from when a green pixel is specified as the pixel of interest, or not using some of the output signals when a red pixel or a blue pixel is specified as the pixel of interest, it is also possible to provide two different pixel extractors, one for the case in which a green pixel is specified as the pixel of interest and another for the case in which a red pixel or a blue pixel is specified as the pixel of interest.

By determining the pixels to be used when the pixel of interest is a green pixel, a red pixel, and a blue pixel as above, pixels at like distances from the pixel of interest P33 are selected for summation for all cases (green pixel, red pixel, blue pixel), so that pixel summation can be performed with reduced occurrence of false colors.

The signal separator 350 separates the composite signal MIX(F2, P33) of the pixel of interest P33 in the frame of interest F2 into an intra-plane sensitized signal VAL(F2, P33) and a pixel summing pattern code PAT(F2, P33).

The intra-plane sensitized signal VAL(F2, P33) and the pixel summing pattern code PAT(F2, P33) output from the signal separator 350 are supplied to the first to fourth pixel selectors 351 to 354 in the summation pixel selector 35.

The intra-plane sensitized signal VAL(F2, P33) is also supplied to the pixel summation unit 39.

The configuration of the pixel selectors 351 to 354, and their operation when a green pixel is specified as the pixel of interest will be described first, and subsequently their operation when a red pixel or a blue pixel is specified as the pixel of interest will be described.

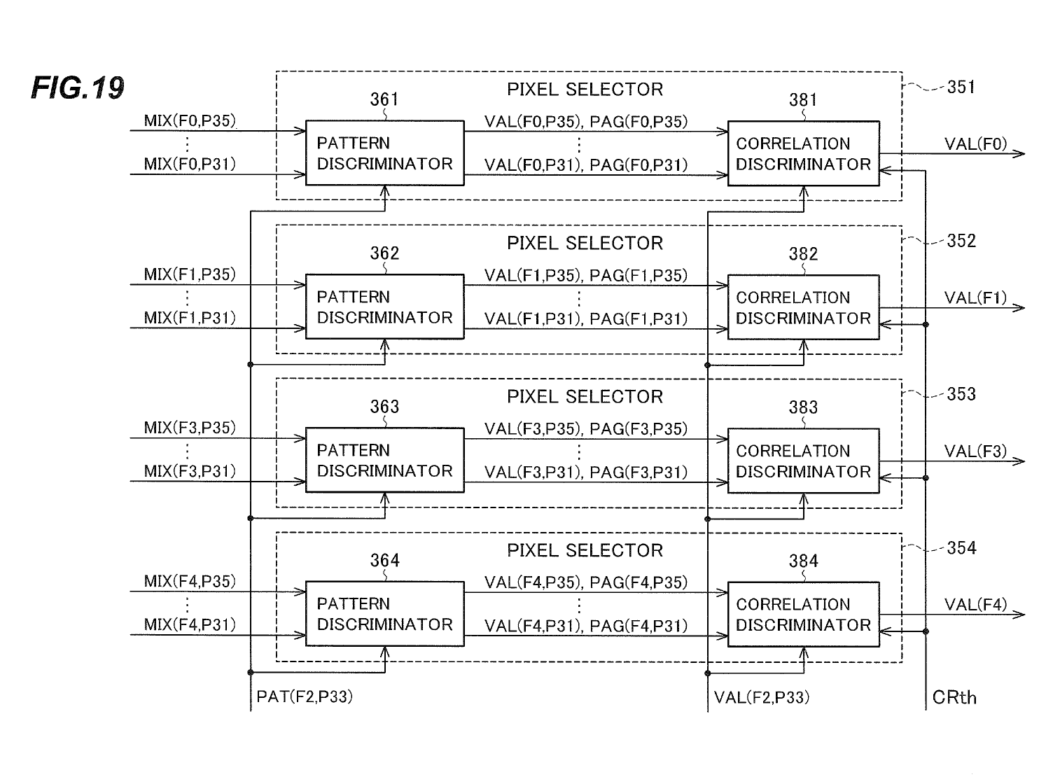

Referring to FIG. 19, the first pixel selector 351 includes a pattern discriminator 361 and a correlation discriminator 381.

The second to fourth pixel selectors 352 to 354 also include respective pattern discriminators 362 to 364 and correlation discriminators 382 to 384.

The pattern discriminators 361 to 364 respectively determine whether or not each of the pixel summing pattern codes PAT in the composite signals MIX output from the pixel extractor 31, that is, in the composite signals MIX of the pixels at the position of the pixel of interest (the position identical to the position of the pixel of interest in the frame of interest) and the pixels at the neighboring positions in the frames F0, F1, F3, and F4 matches the pixel summing pattern code PAT in the composite signal MIX of the pixel of interest in the frame of interest F2, and supply the results of their determinations (agreement information PAG) together with the intra-plane sensitized signals VAL in the composite signals MIX to the corresponding correlation discriminators 381 to 384. In this output, the intra-plane sensitized signal VAL and the agreement information PAG of the same pixel are mutually associated.

Each of the correlation discriminators 381 to 384 makes a comparison with a correlation decision threshold value CRth to decide whether there is a correlation between the intra-plane sensitized signals VAL of the plurality of the pixels (pixels positioned identically to the pixel of interest and the pixels in the neighborhoods of the identically positioned pixels) and the intra-plane sensitized signal VAL(F2, P33) of the pixel of interest P33 in the frame of interest F2 supplied from the signal separator 350.

If there is only one correlated pixel, the intra-plane sensitized signal VAL of the single correlated pixel is selected and output.

If there are multiple correlated pixels, one of the intra-plane sensitized signals VAL of the multiple correlated pixels is selected on the basis of the agreement information PAG. Specifically, if the agreement information PAG of some of the multiple correlated pixels indicates a match, then from among the intra-plane sensitized signals VAL associated with the agreement information PAG indicating a match (pertaining to the same pixel as the agreement information PAG), the signal having the highest correlation with the intra-plane sensitized signal VAL(F2, P33) of the pixel of interest P33 in the frame of interest F2 (the intra-plane sensitized signal VAL with the value closest to that of the intra-plane sensitized signal VAL(F2, P33)) is selected and output.

If the comparisons with the correlation decision threshold value CRth indicate that no correlated pixel is present or if no agreement information PAG indicating a match is present, then from among all the input intra-plane sensitized signals VAL, the signal having the highest correlation with the intra-plane sensitized signal VAL of the pixel of interest is selected and output.

The correlation between two intra-plane sensitized signals VAL is evaluated by the absolute value of the difference between them, for example, and as the absolute value of the difference decreases, the correlation evaluation is found to increase. Accordingly, its correlation is determined to be present when the absolute value of the difference is equal to or less than the threshold value CRth. As the intra-plane sensitized signal with the highest correlation with the intra-plane sensitized signal VAL, the intra-plane sensitized signal having the smallest absolute difference from the intra-plane sensitized signal VAL of the pixel of interest is selected.

When the intra-plane sensitized signal VAL of a pixel is selected, that pixel is selected as a summation pixel.

In the above example, if the comparisons with the correlation decision threshold value CRth show that there is no correlated pixel, or if there is no agreement information PAG indicating a match, then from among all the input intra-plane sensitized signals VAL, the one with the highest correlation to the intra-plane sensitized signal VAL of the pixel of interest is selected and output. Alternatively, the intra-plane sensitized signal VAL of the pixel positioned identically to the pixel of interest may be selected and output. When large noise effects are present, selecting the intra-plane sensitized signal of the pixel positioned identically to the pixel of interest can, in some circumstances, be expected to have a greater noise reduction effect on the sensitized image.

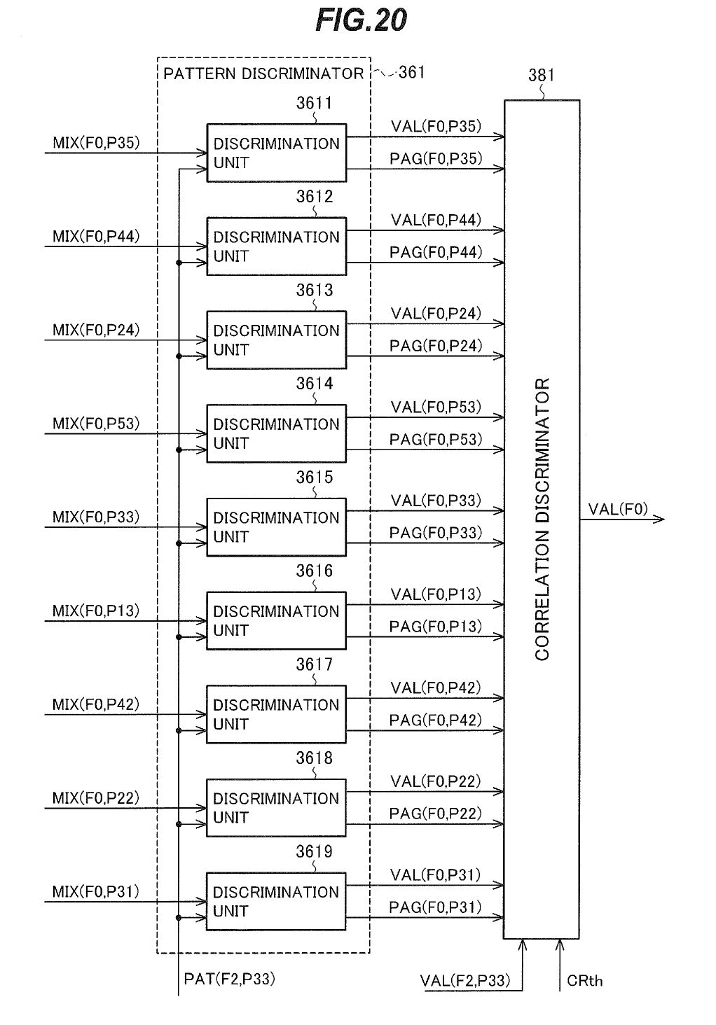

The pattern discriminator 361 in the first pixel selector 351 includes first to ninth discrimination units 3611 to 3619, as shown in FIG. 20.

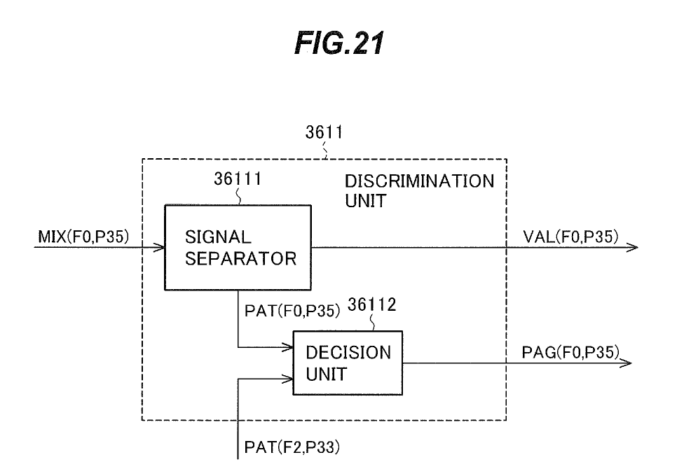

The first discrimination unit 3611 includes a signal separator 36111 and a decision unit 36112 as shown in FIG. 21.

The signal separator 36111 receives the composite signal MIX(F0, P35) of the pixel P35 in the frame F0 and separates it into an intra-plane sensitized signal VAL(F0, P35) and a pixel summing pattern code PAT(F0, P35).

The decision unit 36112 compares the pixel summing pattern code PAT(F0, P35) from the signal separator 36111 with the pixel summing pattern code PAT(F2, P33) from the signal separator 350, decides whether or not the codes match, and outputs information (agreement information) PAG(F0, P35) indicating the result of its decision.

The second to ninth discrimination units 3612 to 3619 are configured in the same way as the first discrimination unit 3611, perform similar processing on the corresponding composite signals MIX(F0, P44), MIX(F0, P24), MIX(F0, P53), MIX(F0, P33), MIX(F0, P13), MIX(F0, P42), MIX(F0, P22), and MIX(F0, P31), and respectively output the intra-plane sensitized signals VAL(F0, P44), VAL(F0, P24), VAL(F0, P53), VAL(F0, P33), VAL(F0, P13), VAL(F0, P42), VAL(F0, P22), VAL(F0, P31) and the agreement information PAG(F0, P44), PAG (F0, P24), PAG (F0, P53), PAG (F0, P33), PAG (F0, P13), PAG(F0, P42), PAG(F0, P22), PAG(F0, P31).

The correlation discriminator 381 calculates the absolute values of differences between the intra-plane sensitized signals VAL(F0, P35), VAL(F0, P44), VAL(F0, P24), VAL(F0, P53), VAL(F0, P33), VAL(F0, P13), VAL(F0, P42), VAL(F0, P22), and VAL(F0, P31) of the pixels P35, P44, P24, P53, P33, P13, P42, P22, and P31 in the frame F0, which are output from the corresponding pattern discriminator 361, and the intra-plane sensitized signal VAL(F2, P33) of the pixel of interest P33 in the frame of interest F2.

When only one pixel with the calculated absolute difference value equal to or less than the threshold value CRth is present, the correlation discriminator 381 selects the intra-plane sensitized signal VAL of that pixel and outputs it.

When multiple pixels with the calculated absolute difference values equal to or less than the threshold value CRth are present, from among the intra-plane sensitized signals VAL of those of the multiple pixels of which the agreement information PAG indicates a match of the pixel pattern code, the correlation discriminator 381 selects the intra-plane sensitized signal VAL having the value closest to the intra-plane sensitized signal VAL(F2, P33) of the pixel of interest P33 in the frame of interest F2, and outputs it as the intra-plane sensitized signal VAL(F0) of the summation pixel selected in the frame F0 (for simplicity, also referred to below as the intra-plane sensitized signal selected in the frame F0).

When there is no intra-plane sensitized signal having an absolute difference from the intra-plane sensitized signal VAL(F2, P33) of the pixel of interest P33 in the frame of interest F2 equal to or less than the threshold value CRth among the intra-plane sensitized signals VAL(F0, P35), VAL(F0, P44), VAL(F0, P24), VAL(F0, P53), VAL(F0, P33), VAL(F0, P13), VAL(F0, P42), VAL(F0, P22), VAL(F0, P31) output from the pattern discriminator 361, or when no pixel of which the agreement information PAG indicates a match of the pixel summing pattern code PAT is present, then from among the intra-plane sensitized signals VAL(F0, P35), VAL(F0, P44), VAL(F0, P24), VAL(F0, P53), VAL(F0, P33), VAL(F0, P13), VAL(F0, P42), VAL(F0, P22), VAL(F0, P31), the correlation discriminator 381 selects the intra-plane sensitized signal VAL having the value closest to the intra-plane sensitized signal VAL(F2, P33) of the pixel of interest P33 in the frame of interest F2, and outputs it as the intra-plane sensitized signal VAL(F0) selected in the frame F0.

The intra-plane sensitized signal VAL(F0) output from the correlation discriminator 381 is supplied as the output of the first pixel selector 351 to the pixel summation unit 39 (FIG. 16).

The second to fourth pixel selectors 352 to 354 are configured in the same way as the first pixel selector 351, respectively perform the same processing as the first pixel selector 351 on the composite signals MIX of the pixels P35, P44, P24, P53, P33, P13, P42, P22, and P31 in the frames F1, F3, and F4, and output the respective intra-plane sensitized signals VAL(F1), VAL(F3), and VAL(F4) for the pixels selected for summation in the frames F1, F3, and F4; that is, they output the intra-plane sensitized signals selected in the frames F1, F3, and F4.

The intra-plane sensitized signals VAL(F0), VAL(F1), VAL(F3), and VAL(F4) output from the first to fourth pixel selectors 351 to 354 are supplied, together with the intra-plane sensitized signal VAL(F2, P33) output from the signal separator 350, to the pixel summation unit 39.

As described above, when the pixel summation is performed by specifying a green pixel as the pixel of interest, the pixel selectors 351 to 354 perform processing by receiving the composite signals MIX of the pixels P35 to P31 in the corresponding frames, respectively. When the pixel summation is performed by specifying a red pixel or a blue pixel as the pixel of interest, the pixel selectors 351 to 354 perform processing by using the composite signals MIX of the pixels P35, P53, P33, P13, and P31 in the corresponding frames, and without using the composite signals MIX of the pixels P44, P24, P42, and P22.

Specifically, when the pixel summation is performed by specifying a green pixel as the pixel of interest, the pattern discriminators 361 to 364 perform processing of receiving the composite signals MIX of the pixels P35 to P31 in the corresponding frames and outputting the intra-plane sensitized signals VAL and the agreement information PAG of the same pixels, and the correlation discriminators 381 to 384 perform processing by using the composite signals MIX of the nine pixels output from the corresponding pattern discriminators 361 to 364, while when pixel summation is performed by specifying a red pixel or a blue pixel as the pixel of interest, the pattern discriminators 361 to 364 perform processing by using the composite signals MIX of the pixels P35, P53, P33, P13, and P31, and without using the composite signals MIX of the pixels P44, P24, P42, and P22, and the correlation discriminators 381 to 384 perform processing by using the composite signals MIX of the five pixels output from the pattern discriminators 361 to 364.

Instead of having the pixel selectors 351 to 354 operate differently when a green pixel is specified as the pixel of interest from when a red pixel or a blue pixel is specified as the pixel of interest, separate pixel selectors may be provided for use when a green pixel is specified as the pixel of interest and for use when a red pixel or a blue pixel is specified as the pixel of interest.

The pixel summation unit 39 adds the intra-plane sensitized signals VAL(F0), VAL(F1), VAL(F3), and VAL(F4) output from the first to fourth pixel selectors 351 to 354 to the intra-plane sensitized signal VAL(F2, P33) output from the signal separator 350.

The control unit 12 sets the sensitivity multiplier Lb (Lb=1 to 5) for the pixel summation unit 39, and, in the summation, a weighting coefficient is multiplied such that the resulting sum has the sensitivity that is boosted by the prescribed factor Lb with respect to the pixel value before the summation.

The calculation for obtaining the sensitized signal Pf(F2, P33) is expressed by the following equation.

Pf(F2,P33)=(VAL(F2,P33)+VAL(F0)+VAL(F1)+VAL(F3)+VAL(F4))×Lb/5

By this summation, the intra-plane sensitized signals VAL(F0), VAL(F1), VAL(F3), and VAL(F4) of a total of four pixels that are highly correlated with the pixel of interest, respectively selected from the four neighboring frames ahead of and behind the frame of interest F2 are added to the intra-plane sensitized signal VAL(F2, P33) of the pixel of interest P33 in the frame of interest F2, to obtain a three-dimensionally sensitized signal Pf(F2, P33) in which the sensitivity of the intra-plane sensitized signal VAL(F2, P33) has been boosted by the prescribed factor Lb.

The generated three-dimensionally sensitized signal Pf(F2, P33) is supplied through the output terminal 602 to the image signal processor 7.

The product of the sensitivity multiplier La of the intra-plane pixel summation unit 20 and the sensitivity multiplier Lb of the inter-plane pixel summation unit 30 is the sensitivity multiplier L of the three-dimensional pixel summation unit 6.

This sensitivity multiplier L is determined by the relationship with the subject illuminance.

For example, when the subject illuminance is equal to or greater than a first prescribed value (upper illuminance reference value), the sensitivity multiplier L is set to 1; when the subject illuminance is equal to or less than a second prescribed value (lower illuminance reference value) less than the first prescribed value, the sensitivity multiplier L is set to 20; when the subject illuminance is within a range (middle illuminance range) lower than the upper illuminance reference value and higher than the lower illuminance reference value), the sensitivity multiplier is gradually increased as the illuminance decreases.

In determining the sensitivity multipliers La and Lb to obtain a desired value of the sensitivity multiplier L, the ratio of the sensitivity multiplier La to the sensitivity multiplier Lb may be held constant. Alternatively, when there is substantial image motion and accordingly very high resolution is not required, the sensitivity multiplier La may be set to a relatively large value and the sensitivity multiplier Lb to a relatively small value; when there is little image motion and high resolution is required, the sensitivity multiplier La may be set to a relatively small value and the sensitivity multiplier Lb to a relatively large value.

In the pixel summation in the intra-plane pixel summation unit 20, weighted summation may be performed by multiplying the pixel values of the pixels by coefficients with different values. For example, in the summation in the pixel summation unit 595, when the sensitivity multiplier La is 1, the weighting coefficient for the pixel of interest may be set to 1 and the weighting coefficients of the other pixels may be set to 0; when the sensitivity multiplier La has the maximum value, such as 4, for example, the weighting coefficients for all pixels may be set to the same value; when the sensitivity multiplier La has a value between 1 and 4, the weighting coefficient may be continuously varied from the value for the sensitivity multiplier of 1 to the value for the maximum sensitivity multiplier La.

Similarly, in the summation of intra-plane sensitized signals VAL in the inter-plane pixel summation unit 30, weighted summation may be performed by multiplying the intra-plane sensitized signals of the pixels in the respective frames by weighting coefficients with different values. For example, when the sensitivity multiplier Lb is 1, the weighting coefficient for the intra-plane sensitized signal of the pixel of interest may be set to 1 and weighting coefficients for the pixels in other frames may be set to 0; when the sensitivity multiplier Lb has the maximum value, such as 5, for example, the weighting coefficients for all the pixels may be set to the same value; when the sensitivity multiplier Lb has a value between 1 and 5, the weighting coefficient may be continuously varied from the value for the sensitivity multiplier of 1 to the value for the maximum sensitivity multiplier Lb.

In the above embodiment, description is made of intra-plane pixel summation in which the sensitivity multiplier La is set to values up to 4, but La may be set to a value greater than 4. When the sensitivity multiplier La is set to a value greater than 4, it should be noted that skipping of gradation levels (missing gradations) may occur.

Similarly, in the above embodiment, description is made of the intra-plane pixel summation in which the sensitivity multiplier Lb is set to values up to 5. But the sensitivity multiplier Lb may be set to a value greater than 5. When the sensitivity multiplier Lb is set to a value greater than 5, it should be noted that skipping of gradation levels may occur.

In the above embodiment, for the pixel of interest in the frame of interest, one pixel is selected from each of the four frames in the neighborhood of the frame of interest, and the intra-plane sensitized signals of five pixels in total are summed. But the number of frames from which the summation pixels are selected is not limited to four. The number may be increased or reduced. Only one frame, such as the frame just before or just after the frame of interest, may be used, for example.

When the required sensitivity multiplier is not large, reducing the number of neighboring frames in which the summation pixels are selected can reduce the necessary frame memory capacity, resulting in reduced circuit scale and lowered cost.

If pixels from more neighboring frames are included in the summation pixels, sensitivity can be further boosted.

In the above embodiment, the pixel arrangement of the color filters is a red-green-blue (RGB) Bayer array, but provided that the array is based on a four-pixel cell measuring two pixels horizontally and two pixels vertically, the present invention is applicable to other types of arrays and patterns, including an inter-line array, a stripe-line array, a complementary color pattern of yellow, magenta, green, and cyan pixels, an array with white pixels, and other color filter combinations, and yet similar effects can be obtained.

In the above description, the captured image is assumed to be a color image, but the present invention is also applicable to monochrome images.

With a monochrome imaging element which is not provided with color filters, more closely positioned and thus more highly correlated pixels can be added, so that selecting the summation pixels in the same way as the above can boost sensitivity while preserving more resolution.

In the above embodiment, both intra-plane pixel summation and inter-plane pixel summation are formed, so that the total sensitivity multiplier can be made greater than in the case in which intra-plane pixel summation alone or inter-plane pixel summation alone is performed.

The intra-plane pixel summation is performed using the pixels highly correlated with the pixel of interest, degradation of the image resolution can be minimized while boosting sensitivity.

In addition, the pixels to be used in the inter-plane pixel summation are selected on the basis of agreement or disagreement of their pixel summing pattern codes with that in the frame of interest, even when there is image motion, so that sensitivity can be boosted without sacrificing resolution.

The inter-plane pixel summation is performed by using the pixels highly corrected with the pixel of interest, so that degradation of image resolution can be minimized and higher sensitivity can be achieved.

Moreover, in the inter-plane pixel summation, the correlation decision is performed according to the result of comparison of the correlation of the intra-plane sensitized signal of the pixel of interest with the intra-plane sensitized signals of a plurality of pixels supplied from the pattern discriminators with a correlation decision threshold value, and the intra-plane sensitized signals to be added to the intra-plane sensitized signal of the pixel of interest are selected on the basis of the pattern agreement information from among the pixels decided to be correlated, so that it is possible to prevent the addition of the intra-plane sensitized signals of the pixels having a matching pattern but lacking correlation with the pixel of interest, that is, the intra-plane sensitized signals of the pixels unsuitable for addition to the intra-plane sensitized signal of the pixel of interest, and highly correlated neighboring pixels can be added, making it possible to improve sensitivity without loss of resolution.

In the above example, intra-plane pixel summation is initially performed to generate composite signals including an intra-plane sensitized signal and a pixel summing pattern code, and signals generated by frame delay of the composite signals are used for inter-plane pixel summation, so that three-dimensional sensitization using pixels highly correlated with the pixel of interest in the frame of interest can be achieved with a minimum number of reference pixels, resulting in reduced circuit scale and lowered cost.

Furthermore, pixels with the same filter color are added, so that high-sensitivity color images can be obtained without color mixing.

Amplification by an analog amplifier of an image signal captured under low illumination may produce a noise component that exceeds the strength of the signal component. Amplification by a digital amplifier may cause skipping of gradation levels. As described in the above example, the present invention performs sensitization by pixel summation using highly correlated pixels near the pixel of interest in terms of space and time, so that noise can be suppressed to a level lower than the level of the intended signal. For example, two-pixel summation doubles the signal component strength while the strength of the noise component is multiplied by a square root of two, so that the relative strength of the pure signal component is enhanced.

By performing pixel summation immediately after the intended pixels are output from the imaging device (i.e., before processing by the image signal processor 7), high sensitivity signals unaffected by video signal processing can be generated by pixel summation. If pixel summation is performed after video signal processing, the pixels are subject to color synchronization processing and filtering, which involve arithmetic operations using neighboring pixels, so that the loss of horizontal and/or vertical resolution may be greater than anticipated. In addition, there are possibilities of skipping of gradation levels because video signal processing is being performed on a small-amplitude signal. By performing pixel summation immediately after the intended pixels are output from the imaging device (before video signal processing), signal amplitude can be restored by pixel summation before the image information is lost, with the effect of improved visibility of details of the image.

Since non-linear filter processing and/or gradation conversion processing are performed during video signal processing by the image signal processor 7, if a low-amplitude input signal is input, the signal amplitude may be lost. For that reason, even if two-pixel summation is performed on the output of the video signal processing, the amplitude of the resulting video signal is not necessarily double the original amplitude. In the above example, pixel summation is performed before video signal processing, so that it has the effect of providing an image signal with an amplitude doubled if two-pixel summation is performed.

Furthermore, since a reduction in the frame rate can be prevented or mitigated, motion resolution is not degraded, and the degradation of horizontal and vertical resolution can be minimized.

### Second Embodiment

In the first embodiment, the pixels used for the inter-plane pixel summation (summation pixels for the inter-plane pixel summation) are selected from the adjacent frames F1 and F3 one frame period distant from (one frame period behind and one frame period ahead of) the frame of interest F2 and the frames F0 and F4 two frame periods distant from (two frame periods behind and two frame periods ahead of) the frame of interest F2 on the basis of the agreement or disagreement of their pixel summing pattern codes PAT with the pattern code of the pixel of interest in the frame of interest F2, and on the basis of correlations of their intra-plane sensitized signals VAL with the intra-plane sensitized signal VAL of the pixel of interest in the frame of interest F2.

Alternatively, in the frames F0 and F4 two frame periods distant from the frame of interest F2, the summation pixels may be selected on the basis of the agreement or disagreement of their pixel summing pattern codes PAT and correlations of their intra-plane sensitized signals VAL, not with the pixel summing pattern code and the intra-plane sensitized signal of the pixel of interest in the frame of interest, but with the pixel summing pattern codes and the intra-plane sensitized signals of the summation pixels selected in the frames F1 and F3 adjacent on the side of the frame of interest (immediately following the frame F0, and immediately preceding the frame F4), in other words, the frames F1 and F3 adjacent to the frames F0 and F4, and located between the frames F0 and F4, and the frame F2. The frames F0 and F4 may also be referred to as “distant frames” for distinction from the adjacent frames F1 and F3.

Specifically, the summation pixel from the previous frame F3 is selected with reference to the pixel summing pattern code PAT and the intra-plane sensitized signal VAL of the pixel of interest in the frame of interest F2, and the summation pixel from the frame F4 one frame further ahead of the previous frame F3 is selected with reference to the pixel summing pattern code PAT and the intra-plane sensitized signal VAL of the summation pixel from the previous frame F3.

Similarly, the summation pixel from the next frame F1 is selected with reference to the pixel summing pattern code PAT and the intra-plane sensitized signal VAL of the pixel of interest in the frame of interest F2, and the summation pixel from the frame F0 one frame further behind the next frame F1 is selected with reference to the pixel summing pattern code PAT and the intra-plane sensitized signal VAL of the summation pixel from the next frame F1.

The intra-plane sensitized signals VAL of the summation pixels selected in the neighboring frames F0, F1, F3, and F4 as described above are summed with the intra-plane sensitized signal VAL in the frame of interest F2.

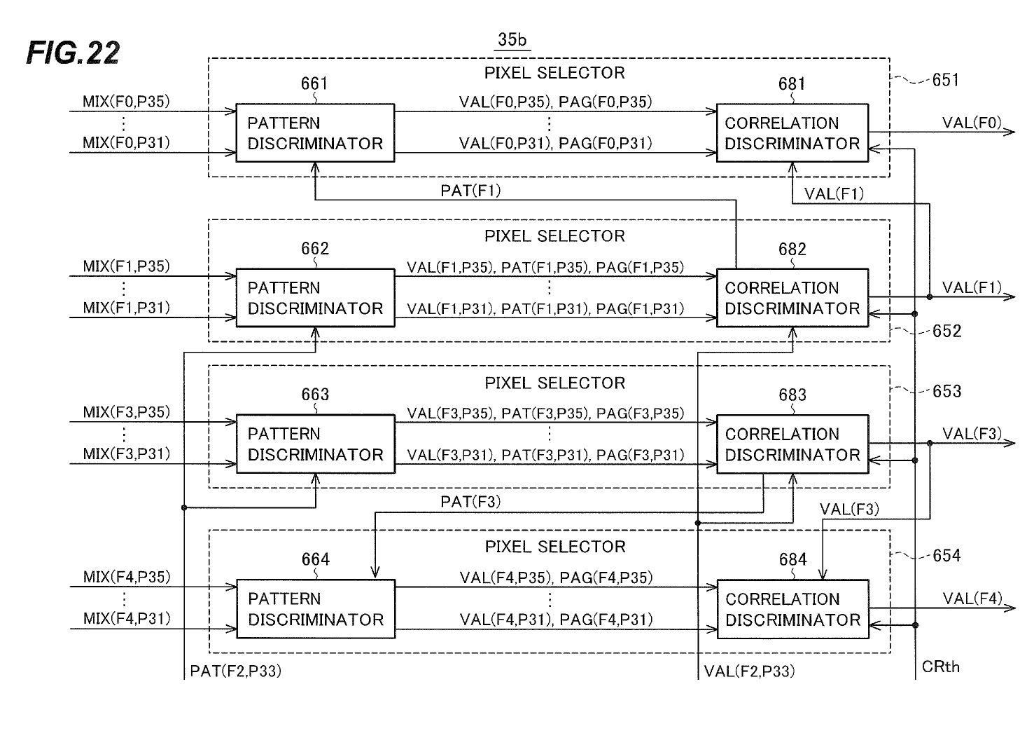

In order to perform the above described processing, the second embodiment uses a summation pixel selector 35b shown in FIG. 22 instead of the summation pixel selector 35 in FIG. 19.

The summation pixel selector 35b in FIG. 22 is similar to the summation pixel selector 35 in FIG. 19, but includes pixel selectors 651 to 654 instead of the pixel selectors 351 to 354 in FIG. 19.

The configuration of the pixel selectors 651 to 654 and their operation when a green pixel is specified as the pixel of interest will be described first, and subsequently their operation when a red pixel or a blue pixel is specified as the pixel of interest will be described.

The pixel selectors 651 to 654 respectively include pattern discriminators 661 to 664 and correlation discriminators 681 to 684.

The pattern discriminators 662 and 663 are substantially the same as the pattern discriminators 362 and 363 in FIG. 19, but they output not only the intra-plane sensitized signals VAL and the agreement information PAG of the pixels in the adjacent frames F1 and F3 but also the pixel summing pattern codes PAT of (pertaining to) those pixels.

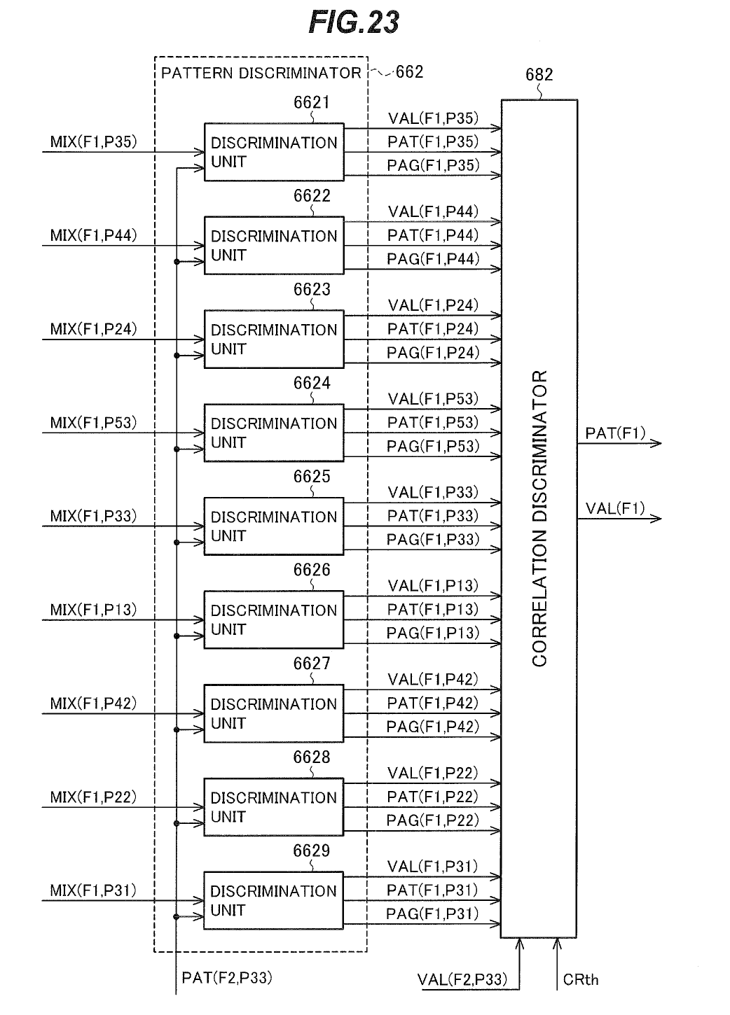

Specifically, as shown in FIG. 23, the pattern discriminator 662 includes discrimination units 6621 to 6629 that output pixel summing pattern codes PAT(F1, P35) to PAT(F1, P31), as well as intra-plane sensitized signals VAL(F1, P35) to VAL(F1, P31) and agreement information PAG(F1, P35) to PAG(F1, P31).

The discrimination units 6621 to 6629 are therefore configured as follows.

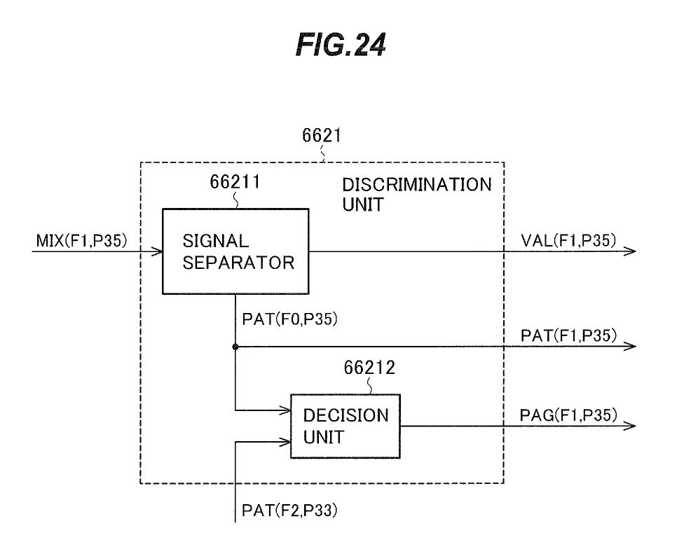

Referring to FIG. 24, the discrimination unit 6621, for example, includes a signal separator 66211 and a decision unit 66212.

The signal separator 66211 is configured in the same way as the signal separator 36111 in FIG. 21, and separates the composite signal MIX(F1, P35) into the intra-plane sensitized signal VAL(F1, P35) and the pixel summing pattern code PAT(F1, P35).

The pixel summing pattern code PAT(F1, P35) output from the signal separator 66211 is supplied to the decision unit 66212 and is also output to the correlation discriminator 682.

The decision unit 66212 is configured in the same way as the decision unit 36112 in FIG. 21, and decides whether or not the pixel summing pattern code PAT(F2, P33) matches the pixel summing pattern code PAT(F1, P35) supplied from the signal separator 66211 and outputs the agreement information PAG(F1, P35).

The other discriminators 6622 to 6629 are configured in the same way, and output the intra-plane sensitized signals VAL(F1, P44) to VAL(F1, P31), the agreement information PAG(F1, P44) to PAG(F1, P31), and the pixel summing pattern codes PAT(F1, P44) to PAT(F1, P31) to the correlation discriminator 682.

The correlation discriminator 682 calculates the absolute values of the differences between the intra-plane sensitized signals VAL(F1, P35) to VAL(F1, P31) and the intra-plane sensitized signal VAL(F2, P33) of the pixel of interest P33 in the frame of interest F2.

If there is only one pixel with the calculated absolute difference value equal to or less than the threshold value CRth, the correlation discriminator 682 selects the intra-plane sensitized signal VAL of that pixel and outputs it.

If there are multiple pixels with the calculated absolute difference values equal to or less than the threshold value CRth, the correlation discriminator 682 selects one of the intra-plane sensitized signals VAL of the multiple pixels. More specifically, if the agreement information PAG of at least one of the multiple correlated pixels indicates a match, then from among all the intra-plane sensitized signals VAL of the pixels with agreement information PAG indicating a match, the correlation discriminator 682 selects the signal with the highest correlation with (the intra-plane sensitized signal VAL having the value closest to) the intra-plane sensitized signal VAL(F2, P33) of the pixel of interest P33 in the frame of interest F2, and outputs it as an intra-plane sensitized signal VAL(F1) of the selected summation pixel in the frame F1 (the intra-plane sensitized signal selected in the frame F1).

If the comparison with the correlation decision threshold value CRth shows that no correlated pixel is present, or if none of the agreement information PAG indicates a match, then from among all the input intra-plane sensitized signals VAL, the one with the highest correlation with the intra-plane sensitized signal VAL of the pixel of interest is selected and output.

More specifically, if none of the intra-plane sensitized signals VAL(F1, P35) to VAL(F1, P31) supplied from the pattern discriminator 662, differ from the intra-plane sensitized signal VAL(F2, P33) of the pixel of interest P33 in the frame of interest F2 by an absolute amount equal to or less than the threshold value CRth, or is associated with agreement information PAG indicating a match of the pixel summing pattern code, the correlation discriminator 682 selects, from among all the input intra-plane sensitized signals VAL(F1, P35) to VAL(F1, P31), the intra-plane sensitized signal VAL having a value closest to the value of the intra-plane sensitized signal VAL(F2, P33) of the pixel of interest P33 in the frame of interest F2 and outputs it as the intra-plane sensitized signal VAL(F1) of the summation pixel selected in the frame F1 (the intra-plane sensitized signal selected in the frame F1).

The intra-plane sensitized signal VAL(F1) of the pixel selected in the frame F1 and output from the correlation discriminator 682 is supplied as the output of the pixel selector 652 to the pixel summation unit 39 (FIG. 16) and also to the correlation discriminator 681.

The correlation discriminator 682 outputs the intra-plane sensitized signal VAL(F1) of the pixel selected in the frame F1, as described above, and supplies the pixel summing pattern code PAT(F1) of the pixel selected in the frame F1 to the pattern discriminator 661.

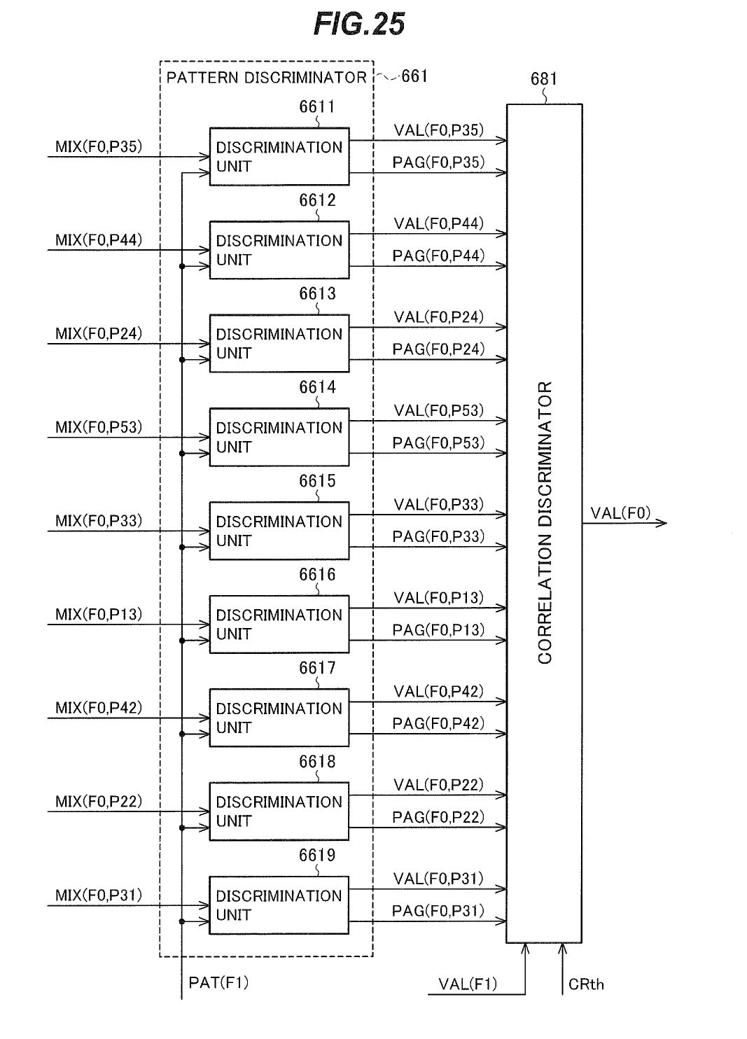

The pattern discriminator 661 includes discrimination units 6611 to 6619 as shown in FIG. 25, uses the pixel summing pattern code PAT(F1) of the pixel selected in the frame F1 instead of the pixel summing pattern code PAT(F2, P33) of the pixel of interest, decides whether this code matches the pixel summing pattern codes PAT of the pixels in the frame F0 supplied from the pixel extractor 21, and outputs agreement information PAG(F0, P35) to PAG(F0, P31) indicating the decision results.

The discrimination units 6611 to 6619 are therefore configured as follows.

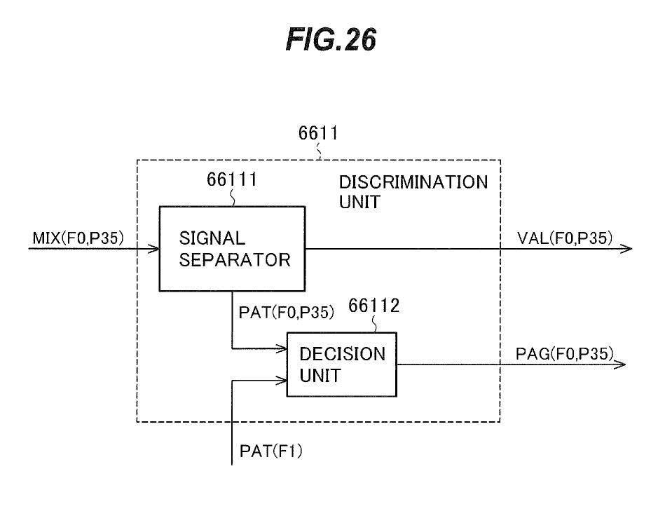

For example, the discrimination unit 6611 includes a signal separator 66111 and a decision unit 66112 as shown in FIG. 26.

The signal separator 66111 is configured in the same way as the signal separator 36111 in FIG. 21, and separates the composite signal MIX(F0, P35) into intra-plane sensitized signal VAL(F0, P35) and pixel summing pattern code PAT(F0, P33).

The decision unit 66112 is configured in the same way as the decision unit 36112 in FIG. 21, but uses the pixel summing pattern code PAT(F1) instead of the pixel summing pattern code PAT(F2, P33), tests for agreement with the pixel summing pattern code PAT(F0, P35) supplied from the signal separator 66111, and outputs the agreement information PAG(F0, P35).

The other decision units 6612 to 6619 are configured in the same way and output the intra-plane sensitized signals VAL(F2, P44) to VAL(F2, P31) and the agreement information PAG(F2, P44) to PAG(F2, P31) to the correlation discriminator 681.

The correlation discriminator 681 calculates correlations with the intra-plane sensitized signals VAL(F0, P35) to VAL(F0, P31) supplied from the corresponding pattern discriminator 661 by using the intra-plane sensitized signal VAL(F1) instead of the intra-plane sensitized signal VAL(F2, P33). Then, on the basis of the calculation results, the correlation discriminator 681 selects a summation pixel, and outputs the intra-plane sensitized signal VAL of the selected summation pixel as the intra-plane sensitized signal VAL(F0) selected in the frame F0.

Specifically, the correlation discriminator 681 calculates the absolute differences between the intra-plane sensitized signals VAL(F0, P35) to VAL(F0, P31) of the pixels in the frame F0 supplied from the pattern discriminator 661 and the intra-frame sensitized signal VAL(F1) selected in the frame F1 and supplied from the pixel selector 652.

If there is only one pixel with the calculated absolute difference equal to or less than the threshold value CRth, the correlation discriminator 681 selects the intra-plane sensitized signal VAL of that pixel and outputs it.

If there are multiple pixels with the calculated absolute differences equal to or less than the threshold value CRth, one of the intra-plane sensitized signals VAL of the multiple pixels is selected. Specifically, if at least one of the multiple correlated pixels has agreement information PAG indicating a match, then from among the intra-plane sensitized signals VAL associated with agreement information PAG indicating a match (pertaining to the same pixels as those having the agreement information PAG indicating a match), the signal having the highest correlation with (the intra-plane sensitized signal VAL having a value closest to) the intra-plane sensitized signal VAL(F1) selected in the frame F1 is selected and output as the intra-plane sensitized signal VAL(F0) selected in the frame F0.

If comparison with the correlation decision threshold value CRth shows that no pixel is correlated, or if no pixel with agreement information PAG indicating a match is present, then from among all the input intra-plane sensitized signals VAL, the signal having the highest correlation with the intra-plane sensitized signal VAL of the pixel of interest is selected and output.

The intra-plane sensitized signal VAL(F0) selected in the frame F0 and output from the correlation discriminator 681 is supplied to the pixel summation unit 39 (FIG. 16) as the output of the pixel selector 651.

The pattern discriminator 663 and the correlation discriminator 683 are configured in the same way as the pattern discriminator 662 and the correlation discriminator 682, receive the pixel summing pattern code PAT(F2, P33) and the intra-plane sensitized signal VAL(F2, P33) of the pixel of interest in the frame of interest from the signal separator 350, perform similar processing on the composite signals MIX(F3, P35) to MIX(F3, P31) of the pixels in the frame F3 input from the pixel extractor 21, and output the intra-plane sensitized signal VAL(F3) selected in the frame F3.

The pattern discriminator 664 and the correlation discriminator 684 are configured in the same way as the pattern discriminator 661 and the correlation discriminator 681, receive the pixel summing pattern code PAT(F3) and the intra-plane sensitized signal VAL(F3) of the pixel selected in the frame F3 from the correlation discriminator 683, perform similar processing on the composite signals MIX(F4, P35) to MIX(F4, P31) of the pixels in the frame F4 input from the pixel extractor 21, and output the intra-plane sensitized signal VAL(F4) selected in the frame F4.

As described above, when pixel summation is performed by specifying a green pixel as the pixel of interest, the pixel selectors 651 to 654 process the composite signals MIX of the pixels P35 to P31 in the corresponding frames. When pixel summation is performed by specifying a red pixel or a blue pixel as the pixel of interest, the pixel selectors 651 to 654 do not use the composite signals MIX of the pixels P44, P24, P42, and P22 in the corresponding frames, but use the composite signals MIX of the pixels P35, P53, P33, P13, and P31 for the processing.

Specifically, when a green pixel is specified as the pixel of interest for pixel summation, the pattern discriminators 661 to 664 respectively perform processing of receiving the composite signals MIX of the pixels P35 to P31 in the corresponding frames, and outputting the intra-plane sensitized signals VAL and the agreement information PAG pertaining to the same pixels, and the correlation discriminators 681 to 684 process the intra-plane sensitized signals VAL and the agreement information PAG of nine pixels output from the pattern discriminators 661 to 664, while when a red pixel or a blue pixel is specified as the pixel of interest for pixel summation, the pattern discriminators 661 to 664 perform the processing by using the composites signals MIX of the pixels P35, P53, P33, P13, and P31, and without using the composite signals MIX of the pixels P44, P24, P42, and P22 in the corresponding frame, and the correlation discriminators 681 to 684 process the intra-plane sensitized signals VAL and the agreement information PAG of the five pixels output from the pattern discriminators 661 to 664.

Instead of having the pixel selectors 651 to 654 operate differently when a green pixel is specified as the pixel of interest from when a red pixel or a blue pixel is specified as the pixel of interest, separate pixel selectors may be provided for use when a green pixel is specified as the pixel of interest and for use when a red pixel or a blue pixel is specified as the pixel of interest.

The above processing enables the summation pixels to be selected more properly in consideration of image motion, and loss of resolution can be reduced.

In the above description, the frames neighboring the frame of interest include the two frames adjacent to the frame of interest and the two frames located two frames ahead of and behind the frame of interest. However, the invention is applicable to a situation where frames located three or more frames away from the frame of interest are included.

In this case, a pixel is selected in each frame by use of the summation pixel patterns PAT and the intra-plane sensitized signals VAL of the adjacent frame located between the above-mentioned each frame and the frame of interest.

More specifically, the pattern discriminator may decide whether or not the pixel summing pattern codes PAT of the pixels in a frame (e.g., a frame m frames distant from the frame of interest, m being a positive integer) match the summation pattern code PAT of the pixel selected in the adjacent frame between it (the above-mentioned each frame) and the frame of interest (the frame m−1 frames distant from the frame of interest), and on the basis of the correlation between the intra-plane sensitized signals VAL of the pixels in the frame m frames distant from the frame of interest and the intra-plane sensitized signals VAL of the pixel selected in the adjacent frame which is m−1 frames distant from the frame of interest and the decision results obtained by the pattern discriminator, the correlation discriminator may select one pixel from among the pixel positioned identically to the pixel of interest and the pixels in the neighborhood of the identically positioned pixel in the frame which is m frames distant from the frame of interest.

### Third Embodiment

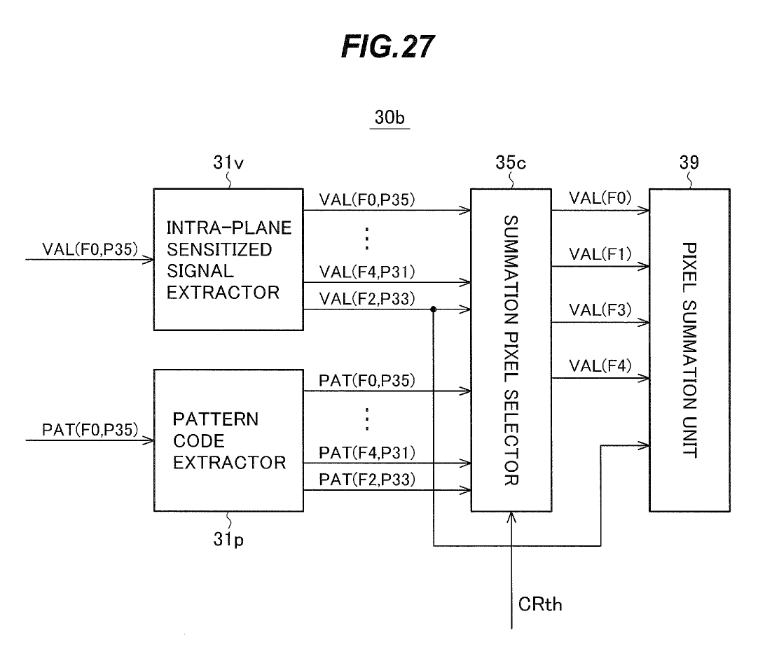

In the first embodiment, the intra-plane pixel summation unit 20 includes a signal combiner 24 and outputs a composite signal MIX, and the pixel extractor 31 in the inter-plane pixel summation unit 30 delays the composite signal MIX by different times, thereby simultaneously extracting the composite signal MIX of the pixel of interest in the frame of interest and the composite signals MIX of the pixels positioned identically to the pixel of interest, and the pixels in the neighborhoods of the identically positioned pixels, in the frames neighboring the frame of interest. But the intra-plane pixel summation unit 20 need not include a signal combiner 24; the pixel summing pattern code PAT and the intra-plane sensitized signal VAL may be output in association with each other but without being combined. In this case the inter-plane pixel summation unit 30b shown in FIG. 27 may be used.

The inter-plane pixel summation unit 30b in FIG. 27 is generally similar to the inter-plane pixel summation unit 30 in FIG. 16, but instead of the pixel extractor 31 in FIG. 16, it includes a pattern code extractor 31p and an intra-plane sensitized signal extractor 31v. The pattern code extractor 31p delays the pixel summing pattern code PAT by different times, thereby simultaneously extracting the pixel summing pattern codes PAT(F0, P35) to PAT(F4, P31) of the pixel of interest in the frame of interest and the pixels positioned identically to the pixel of interest and the pixels in the neighborhoods of the identically positioned pixels in the frames neighboring the frame of interest. The intra-plane sensitized signal extractor 31v delays the intra-plane sensitized signal VAL by different times, thereby simultaneously extracting the intra-plane sensitized signals VAL(F0, P35) to VAL(F4, P31) of the pixel of interest in the frame of interest and the pixels positioned identically to the pixel of interest and the pixels in the neighborhoods of the identically positioned pixels in the frames neighboring the frame of interest.

The signal separator 350 (FIG. 16) in the inter-plane pixel summation unit 30 is not used, and a different summation pixel selector 35c is substituted for the summation pixel selector 35 in FIG. 16.

The summation pixel selector 35c is similar to the summation pixel selector 35 in FIG. 19, but the discrimination units (corresponding to the discrimination units 3611 to 3619 in FIG. 20) of the pattern discriminators 361 to 364 do not include a signal separator (such as signal separator 36111 in FIG. 21). Each of the pixel summing pattern codes PAT of the pixels in each of the frames neighboring the frame of interest, supplied from the pattern code extractor 31p, is compared with the pixel summing pattern code PAT of the pixel of interest in the frame of interest in a decision unit (corresponding to the decision unit 36112 in FIG. 21). The comparisons with the threshold value CRth are performed in a correlation discriminator (corresponding to the correlation discriminator 381 in FIG. 20). The results of these comparisons are output.

### Fourth Embodiment

In the first embodiment, a CCD imaging element 2 is used as a solid state imaging device, as shown in FIG. 1. But a complementary metal-oxide semiconductor (CMOS) imaging element, or any other two-dimensional image sensor may be used instead. When a CCD imaging element is used, it is not limited to the interline transfer type; a frame transfer CCD or a frame interline transfer CCD may be used instead.

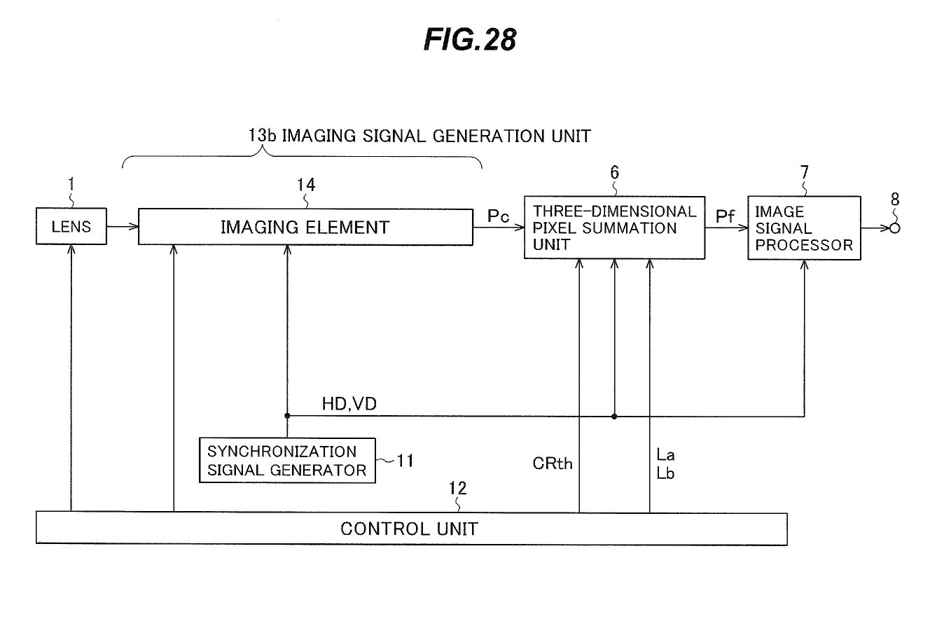

FIG. 28 shows a configuration using a CMOS imaging element 14. The CMOS imaging element may have only an imaging function, or it may be a device with integrated peripheral functions. The imaging element 14 in FIG. 28 is assumed to be a CMOS imaging device with integrated peripheral functions.

The functions of the CCD imaging element 2, the correlated double sampling unit 3, the programmable gain amplifier 4, the ADC 5, and the timing generator 10 in FIG. 1 are included in the CMOS imaging element 14, so that the CMOS imaging element 14 by itself constitutes an imaging signal generation unit 13b having functions equivalent to those of the imaging signal generation unit 13 in FIG. 1, i.e., the functions of generating an imaging signal with multiple color components obtained as a result of imaging a subject.

### Fifth Embodiment

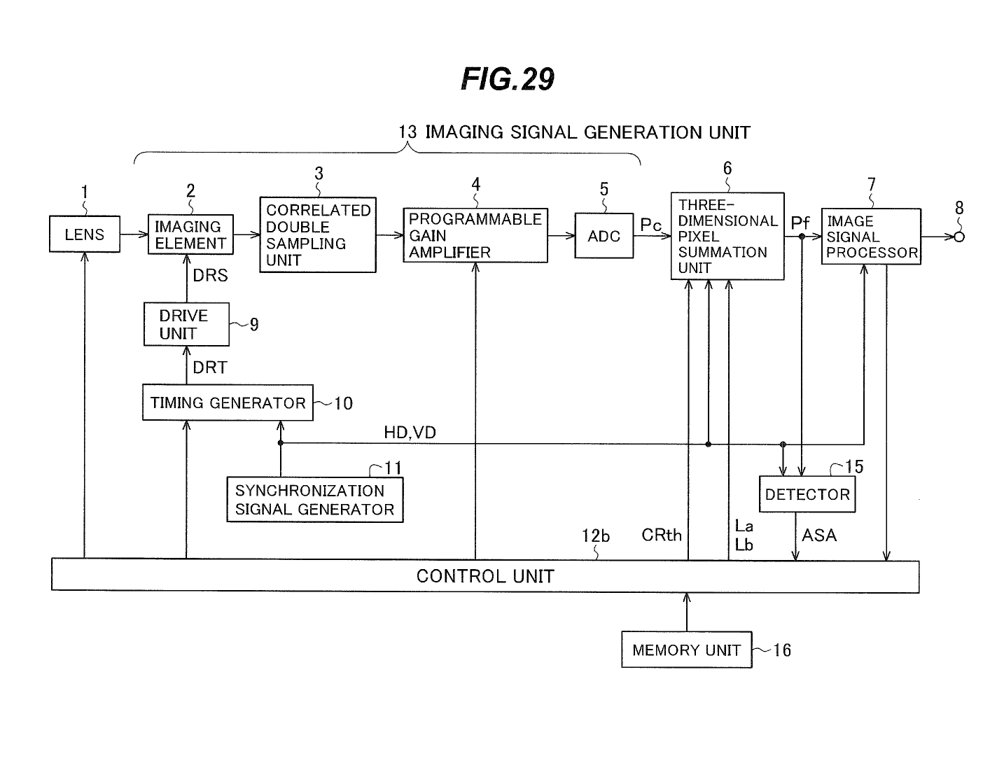

FIG. 29 shows the imaging device in the fifth embodiment of the present invention. The imaging device in FIG. 29 is the same as in the first embodiment, except for the addition of a detector 15 and the substitution of a control unit 12b for the control unit 12 in FIG. 1. The effects produced in the first embodiment are also obtained in the fifth embodiment.

The detector 15 detects the magnitude of the signal Pf output from the three-dimensional pixel summation unit 6, determines the signal amplitude level, e.g., the average level (ASA value), and outputs the amplitude level information as illuminance information.

In the above detection, the detector 15 determines a calculated value ASA of the average level of the signal amplitude by dividing the total of the pixel values of all the effective pixels by the total number of effective pixels.

The calculation of the average level is executed, for example, by an integration process and a division process carried out in each vertical period. The calculated value of the average amplitude level of the signal may also referred to as the ‘detected value’.

When the number of pixels is a power of two (2ⁿ, n being an integer), the division by the total number of effective pixels in the above calculation of the average level of the signal amplitude may be carried out as a digital bit shift process. Since the total number of effective pixels is a constant value within the system, the division by the total number of effective pixels may be omitted.

The control unit 12b is similar to the control unit 12 in the first embodiment, except that it has the following additional functions. That is, the control unit 12b performs control of the aperture of the lens 1, control of the timings generated by the timing generator 10 for charge reading and flushing from the photoelectric conversion element in the CCD imaging element 2 (accordingly, control of charge accumulation time, or exposure time), control of the amplification factor of the programmable gain amplifier 4, and control of pixel summation processing by the three-dimensional pixel summation unit 6, on the basis of the detected value ASA of the average level of the signal amplitude supplied from the detector 15.

Furthermore, the image signal processor 7 calculates the level of noise included in the output of the three-dimensional pixel summation unit 6 at each vertical period and supplies the result to the control unit 12b.

Instead of calculating the average level of the signal amplitude and the noise level in each vertical period, in consideration of the signal processing time in the detector 15 and the image signal processor 7 and the time required for transmission of the signal processing results to the control unit 12b, the detector 15 and the image signal processor 7 may instead calculate these levels may be calculated only once per several vertical periods.

The detector 15 may perform peak detection of the signal amplitude instead of calculating the average level of the signal amplitude. The output of the detector 15 is generated to improve the visibility of the subject of interest. For example, the detector 15 may perform peak detection when it is desired to avoid white saturation in the highlighted portion. Average value detection may be performed when white saturation in the highlighted portion can be tolerated but intermediate gradations need to be clearly visible.

As described in detail below, sensitivity control by the three-dimensional pixel summation unit 6 can be carried out as part of exposure control, so that even if the illumination environment changes, the effect of keeping the subject constantly visible under the optimal imaging conditions can be obtained. The signal amplitude can also be adjusted by varying the weighting coefficient in the three-dimensional pixel summation unit 6.

The control unit 12b performs automatic exposure control to hold the detected value ASA of the average level of the signal amplitude obtained by the detector 15 at a constant level. When the image is captured in a bright environment and the signal amplitude is large, the control unit 12b performs control to reduce the aperture of the lens 1, thereby reducing the amount of light incident on the CCD imaging element 2, or, in adjustment of the timing of charge flushing by the timing generator 10, it reduces the exposure time by performing control to force the flushing of the electrical charges that accumulate in the photoelectric conversion element in the CCD imaging element 2.

When the image is captured in a dark environment and the signal amplitude is small, the control unit 12b controls the programmable gain amplifier 4 to increase the amplification factor, thereby amplifying the imaging signal. Increasing the amplification factor too much, however, accentuates image noise and degrades image quality. As an alternative method, the control unit 12b can lengthen the exposure time by performing control to read the charges from the photoelectric conversion element in the CCD imaging element 2 at longer intervals, lengthening the intervals in units of the vertical period. Too long an exposure time, however, causes ghosts, resulting in degradation of image quality, and it then becomes necessary to provide an interpolation unit to interpolate the missing images in the skipped vertical periods.

As in the first embodiment, the control unit 12b in this embodiment can vary the sensitivity multiplier L for the three-dimensional pixel summation unit 6, by setting L in the range from 1 to 20, for example. This setting (adjustment) of the sensitivity multiplier L is performed according to the illuminance information from the detector 15 and exposure parameters. The sensitivity multiplier La for intra-plane pixel summation and sensitivity multiplier Lb for inter-plane pixel summation are then set on the basis of the adjusted sensitivity multiplier L.

As described in the first embodiment, the weighting coefficient used in the pixel summation by the pixel summation unit 595 in the intra-plane pixel summation unit 20 is adjusted according to the sensitivity multiplier La and the weighting coefficient used in the pixel summation by the pixel summation unit 39 in the inter-plane pixel summation unit 30 is adjusted according to the sensitivity multiplier Lb. Accordingly, the weighting coefficients for intra-plane pixel summation and inter-plane pixel summation are adjusted on the basis of the illuminance information.

An exemplary procedure for adjusting sensitivity when the subject illuminance has changed will now be described. First, the description will be given on the assumption that the exposure time is kept at a constant value Tr (referred to as the reference exposure time).

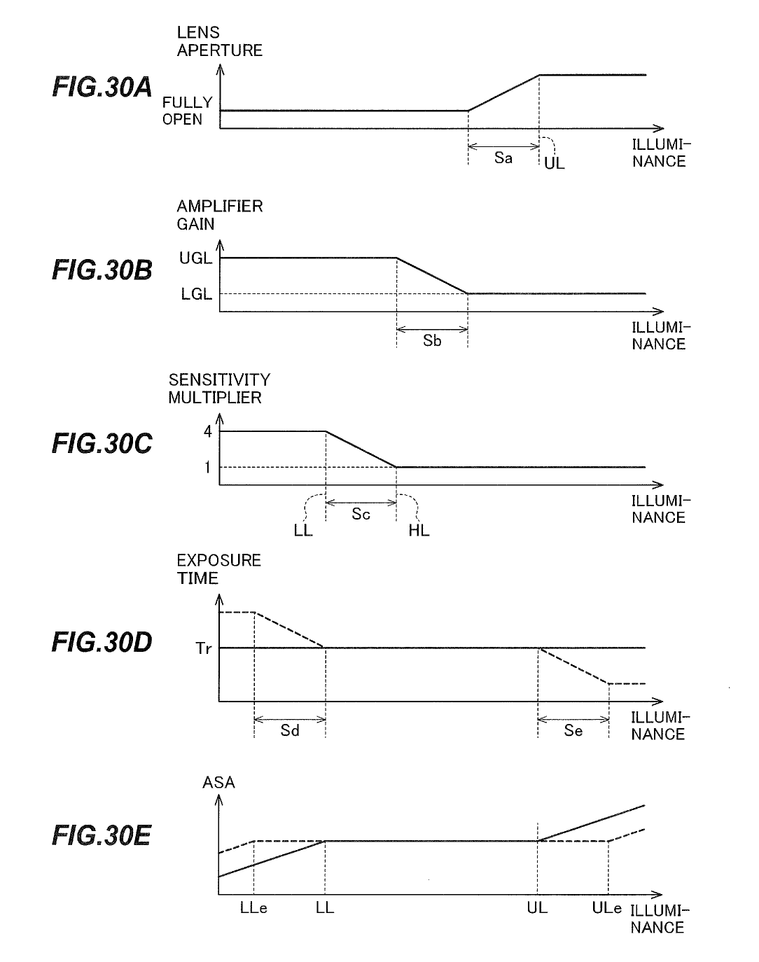

When the subject illuminance becomes gradually lower and the detected value ASA of the average level of the signal amplitude starts to decrease (FIG. 30E), the aperture of the lens 1 is gradually widened (as shown in range Sa in FIG. 30A) to maintain a constant average level of the signal amplitude. “Maintaining (or holding) a constant average level of the signal amplitude” means keeping the average level of the amplitude of the signal output from the three-dimensional pixel summation unit 6 steady, and hence keeping the average level ASA of the signal amplitude represented by the output of the detector 15 steady.

After the aperture of the lens 1 is fully open, the amplification factor of the programmable gain amplifier 4 is gradually increased (as shown in range Sb in FIG. 30B) to hold the same average level of the signal amplitude steady. When the amplification factor of the programmable gain amplifier 4 reaches a prescribed upper limit value UGL of the amplification factor, the sensitivity multiplier L of the three-dimensional pixel summation unit 6 is gradually increased (as shown in range Sc in FIG. 30C) to hold the average level of the signal amplitude steady.

The average level ASA can be maintained by control of the sensitivity multiplier L until the sensitivity multiplier L reaches its maximum value (L=20). If the subject illuminance becomes still lower, the average level ASA starts to decrease.

The illuminance HL at which the output of the three-dimensional pixel summation unit 6 reaches a prescribed level using the reference exposure time Tr, with the lens aperture fully open, the maximum amplification factor, and a sensitivity multiplier of unity (L=1), is set as a high illuminance reference value. An illuminance equal to one twentieth of the high illuminance reference value HL, that is, the illuminance LL at which the output of the three-dimensional pixel summation unit 6 reaches the prescribed level using the reference exposure time Tr, with the lens aperture fully open, the maximum amplification factor, and the maximum sensitivity multiplier (L=20), is set as a low illuminance reference value.

When the subject illuminance gradually becomes brighter than the low illuminance reference value LL and the detected value ASA of the average level of the signal amplitude starts to increase, the sensitivity multiplier L of the three-dimensional pixel summation unit 6 is gradually reduced (as shown in range Sc in FIG. 30C) to hold the average level ASA of the signal amplitude steady. When the sensitivity multiplier L decreases to 1, the amplification factor of the programmable gain amplifier 4 is gradually reduced to hold the average level ASA of the signal amplitude steady. After the amplification factor of the programmable gain amplifier 4 has decreased (as shown in range Sb in FIG. 30B) to the prescribed lower limit LGL=and, the aperture of the lens 1 is controlled so as to block more light (the range Sa in FIG. 30A) to hold the average level of the signal amplitude steady (FIG. 30E). If the illuminance increases further, the average level ASA rises.

As a result of the above-described control, the average level ASA of the signal amplitude can be kept constant as indicated by the solid line in FIG. 30E, in the range from the lower limit LL to the upper limit UL.

In the above example, the exposure time is assumed to be constant. But it may be controlled according to the subject illuminance. For example, if the illuminance decreases so far that the signal amplitude is inadequate even with the sensitivity multiplier L at its maximum value, the exposure time may be extended (as shown in range Se in FIG. 30D). Conversely, if the illuminance increases so much that the signal amplitude is too large even when the lens aperture is stopped down as far as possible (that is, even at the maximum f-value), the exposure time may be reduced (as shown in range Se in FIG. 30D).

By controlling the exposure time in this way, the average level of the signal amplitude can be kept constant in the range from a lower limit LLe to an upper limit ULe, as indicated by the dashed lines in FIG. 30E.

The prescribed upper limit value UGL of the amplification factor is determined depending on the noise level detected value ANL detected by the image signal processor 7. (Considering the necessity to increase the amplification factor when the subject illuminance decreases and hence the signal-to-noise (S/N) ratio of the output of the imaging element 2 decreases), the amplification factor of the programmable gain amplifier 4 when the noise level detected value ANL reaches a prescribed noise ratio NPR1 (a first prescribed noise ratio, or an upper permissible value) with respect to the detected value ASA of the average level of the signal amplitude is set as the prescribed upper limit value UGL. The first prescribed noise ratio NPR1 is set at 1/50, for example.

The calculated value ANL of the noise level is determined by extracting noise components by noise reduction processing and dividing the total sum of the absolute values of the noise components within the range of all effective pixels by the total number of the effective pixels. Noise reduction processing produces a noise reduced signal NRS, equivalent to the input signal but with reduced noise. The noise components can be extracted by subtracting the noise reduced signal NRS from the input signal (the signal before undergoing noise reduction processing in the image signal processor 7). The calculated value obtained in this way is also referred to above as the ‘detected value’.

Since the acceptable noise level for viewing the subject differs depending on the application, the first prescribed noise ratio NPR1 varies is determined depending on depending on the purpose for which the imaging device is used, that is, for example, whether weight is given to the S/N ratio, whether weight is given to image resolution, etc. The control unit 12b may control the programmable gain amplifier 4 and the three-dimensional pixel summation unit 6 by dynamically determining the prescribed upper limit value UGL of the amplification factor while observing the amplification factor set for the programmable gain amplifier 4 and the noise level detected value ANL supplied from the image signal processor 7 to the control unit 12b. Alternatively, the amplification factor at which the noise level detected value ANL reaches the first prescribed noise ratio NPR1 with respect to the detected value ASA of the average level of the signal amplitude may be measured before the imaging device is shipped from the factory, and the measured value may be written as the prescribed upper limit value UGL in a memory unit 16 capable of retaining data even when the imaging device is powered off, such as a non-volatile memory, a battery backed-up volatile memory, etc., and then referred to by the control unit 12b in controlling the programmable gain amplifier 4 and three-dimensional pixel summation unit 6.

The prescribed lower limit value LGL of the amplification factor is determined depending on the noise level detected value ANL supplied from the image signal processor 7 to the control unit 12b. The amplification factor of the programmable gain amplifier 4 when the noise level detected value ANL becomes lower than the detected value ASA of the average level of the signal amplitude by a prescribed noise ratio (a second prescribed noise ratio) NPR2 is set as the prescribed lower limit value LGL. The second prescribed noise ratio is determined on the basis of the first prescribed noise ratio NPR1 and the sensitivity multiplier (×20) of the three-dimensional pixel summation unit 6. For example, the second prescribed noise ratio NPR2 can be set to 1/1000(=( 1/50)×( 1/20)).

Since the acceptable noise level for viewing the subject differs depending on the application, the second prescribed noise ration NPR2 is determined depending on depending on the purpose for which the imaging device is used, that is, for example, on whether weight is given to the S/N ratio, whether weight is given to image resolution, etc. The control unit 12b may control the programmable gain amplifier 4 and the three-dimensional pixel summation unit 6 by dynamically determining the prescribed lower limit value LGL of the amplification factor while observing the amplification factor set for the programmable gain amplifier 4 and the noise level detected value ANL supplied from the image signal processor 7 to the control unit 12b. Alternatively, the amplification factor at which the noise level detected value ANL reaches the second prescribed noise ratio NPR2 with respect to the detected value ASA of the average level of the signal amplitude may be measured before the imaging device is shipped from the factory, and the measured value may be written as the prescribed lower limit value LGL in a memory unit 16 capable of retaining data even when the imaging device is powered off, and then referred to by the control unit 12b in controlling the programmable gain amplifier 4 and three-dimensional pixel summation unit 6.

By controlling the aperture of the lens 1, the exposure time of the CCD imaging element 2, the amplification factor of the programmable gain amplifier 4, and the signal amplitude adjustment function by pixel summation in the three-dimensional pixel summation unit 6, the control unit 12b maintains a constant average level of the signal amplitude (the average level of the signal amplitude of the output of the three-dimensional pixel summation unit 6).

Since the above-described control is performed, a value obtained by performing an inverse conversion operation on the value of the output of the detector 15, based on the exposure control parameters, corresponds to the subject illuminance. It is accordingly possible to determine whether the illuminance obtained by the inverse conversion operation is equal to or greater than the high illuminance reference value, is equal to or less than the lower illuminance reference value, or falls in the range between these reference values, and control pixel summation (adjustment of the sensitivity) according to the result of this determination.

The configuration described above has the effect of enabling the output of images with good visibility and optimal brightness by sequential switching among the lens aperture control, the amplification factor control, the pixel summation control, and the exposure time control, in the exposure control.

In addition, since the sensitivity multiplier can be set by a weighting coefficient, rather than by the number of pixels added by the pixel summation units, and the sensitivity multiplier L can be set not only to integer values but also fractional values, this embodiment has the effect that in the exposure control, the pixel summation control can be made seamlessly by using values including fraction digits for the weighting coefficient, so that abrupt changes in brightness can be avoided in the course of illumination changes, and easily viewable images can be output.

### Sixth Embodiment

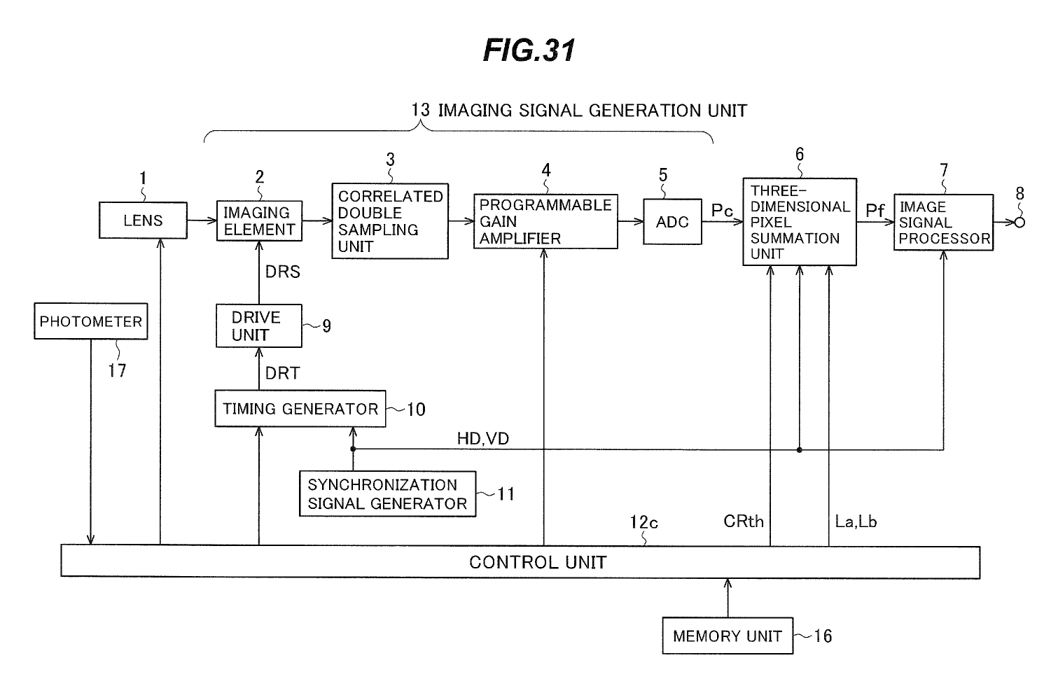

FIG. 31 shows the imaging device in the sixth embodiment of the present invention. The imaging device in FIG. 31 is the same as in the first embodiment, except for the addition of a photometer 17 and the substitution of a control unit 12c for the control unit 12 in FIG. 1. The effects produced in the first embodiment are also obtained in the sixth embodiment.

The photometer 17 measures the subject illuminance in the direction of light incident on the lens 1. The illuminance sensor (not shown) in the photometer 17 is mounted and positioned based on the optical axis of the lens, and measures the illuminance of the subject imaged by the lens 1.

The control unit 12c is similar to the control unit 12 in the first embodiment except that it has the following additional functions. That is, the control unit 12c performs control of the aperture of the lens 1, control of the timings generated by the timing generator 10 for charge reading and flushing from the photoelectric conversion element in the CCD imaging element 2 (accordingly, control of charge accumulation time, or exposure time), control of the amplification factor of the programmable gain amplifier 4, and control of pixel summation processing by the three-dimensional pixel summation unit 6, on the basis of the illuminance value supplied from the photometer 17.

The control unit 12c performs settings of the aperture of the lens 1, the exposure time of the CCD imaging element 2, the amplification factor of the programmable gain amplifier 4, and the sensitivity multiplier of the three-dimensional pixel summation unit 6 according to a set value table held in the memory unit 16.

The set value table stores values of the aperture of the lens 1, the exposure time of the CCD imaging element 2, the amplification factor of the programmable gain amplifier 4, and the sensitivity multiplier of the three-dimensional pixel summation unit 6 for each illuminance value.

When the illuminance is bright, the exposure time of the imaging element 2 is set to a reference exposure time Tr based on the frame rate, the amplification factor of the programmable gain amplifier 4 is set to 1, and the sensitivity multiplier L of the three-dimensional pixel summation unit 6 is set to 1, and the lens aperture of the lens 1 is reduced (the range Sa in FIG. 30A). When the aperture of the lens 1 has been reduced as far as possible, if the illuminance becomes still brighter, the exposure time of the imaging element 2 is reduced below the reference exposure time Tr (the range Se in FIG. 30D).

When the illuminance darkens, the exposure time of the imaging element 2 is set to the reference exposure time Tr based on the frame rate, the amplification factor of the programmable gain amplifier 4 is set to 1, and the sensitivity multiplier L of the three-dimensional pixel summation unit 6 is set to 1, and the aperture of the lens 1 is widened (the range Sa in FIG. 30A). When the aperture of the lens 1 is fully open and the illuminance becomes still darker, the amplification factor of the programmable gain amplifier 4 is increased from 1 to a higher value (the range Sb in FIG. 30B). When the amplification factor reaches the above-mentioned upper limit value (the value of the amplification factor at which the level of noise included in the output of the three-dimensional pixel summation unit 6 reaches the first prescribed ratio, that is, the maximum gain value satisfying the condition that the noise level does not exceed the first prescribed ratio (the upper limit value of the acceptable range) and the illuminance becomes still darker, the sensitivity multiplier of the three-dimensional pixel summation unit 6 is increased from 1 to a higher value (the range Sc in FIG. 30C). When the illuminance becomes still darker, the exposure time is increased (in range Sd in FIG. 30D).

The configuration described above has the effect of enabling the output of images with good visibility and optimal brightness by sequential switching among the lens aperture control, the amplification factor control, the pixel summation control, and the exposure time control, in the exposure control.

In addition, since the sensitivity multiplier can be set by a weighting coefficient, rather than by the number of pixels added by the pixel summation units, and the sensitivity multiplier L can be set not only to integer values but also fractional values, this embodiment has the effect that in the exposure control, the pixel summation control can be made seamlessly by using values including fraction digits for the weighting coefficient, so that abrupt changes in brightness can be avoided in the course of illumination changes, and easily viewable images can be output.

In the fifth and sixth embodiments, the exposure time is extended when the signal amplitude is inadequate even though the sensitivity multiplier has been set to its maximum value. This is a result of giving priority to keeping the frame rate unchanged. When weight is placed on the resolution rather than the frame rate, control to extend the exposure time may be performed first, and when the signal amplitude is inadequate even though the exposure time has been extended (e.g., to a prescribed value), the sensitivity multiplier may then be increased, or control to increase the sensitivity multiplier and control to extend the exposure time may be performed concurrently.

Those skilled in the art will recognize that further variations are possible within the scope of the invention, which is defined in the appended claims.

What is claimed is:

1. An imaging device comprising:
an imaging signal generation unit configured to capture images and generate an imaging signal indicating a pixel value for each pixel in a plurality of pixels constituting a sequence of temporally consecutive frames;
an intra-plane pixel summation unit configured to:
receive the imaging signal generated by the imaging signal generation unit,
sequentially specify the pixels in each of the consecutive frames,
select, for each specified pixel, an area consisting of pixels with high mutual correlation, from among a plurality of areas having predetermined relative positions or orientations with respect to the specified pixel,
sum the pixel values of the pixels in the selected area,
output a resulting sum as an intra-plane sensitized signal of the specified pixel, and
output a pixel summing pattern code indicating the relative position or orientation of the selected area; and
an inter-plane pixel summation unit configured to:
sequentially specify the consecutive frames as a frame of interest,
sequentially specify the pixels in the frame of interest as a pixel of interest,
select, for each pixel of interest, a pixel from each of one or more frames neighboring the frame of interest, on a basis of correlations of the intra-plane sensitized signal of the pixel of interest with the intra-plane sensitized signals of a pixel positioned identically to the pixel of interest and pixels in a neighborhood of the identically positioned pixel, results of comparisons of the correlations with a correlation decision threshold value, and the relative position or orientation of each of the selected areas with respect to the specified pixel,
add the intra-plane sensitized signals of the selected pixels in the one or more frames neighboring the frame of interest to the intra-plane sensitized signal of the pixel of interest, and
output a resulting sum as a three-dimensionally sensitized signal.

2. The imaging device of claim 1, wherein the intra-plane pixel summation unit comprises:
an area selector configured to select, for each specified pixel, the area consisting of pixels with high mutual correlation and output the pixel summing pattern code indicating the relative position or orientation of the selected area; and
a selective summation unit configured to output the resulting sum obtained by summing the pixel values of the pixels included in the area selected by the area selector as the intra-plane sensitized signal of the specified pixel; and wherein
the inter-plane pixel summation unit selects one pixel in an adjacent frame adjacent to the frame of interest, among the frames neighboring the frame of interest, on a basis of
results of comparisons of differences between the intra-plane sensitized signal of the pixel positioned identically to the pixel of interest and pixels in the neighborhood of the identically positioned pixel in the adjacent frame with the correlation decision threshold value, and
results of comparisons of the pixel summing pattern code of the pixel positioned identically to the pixel of interest and the pixels in the neighborhood of the identically positioned pixel in the adjacent frame with the pixel summing pattern code of the pixel of interest.

3. The imaging device of claim 2, wherein,
if, among the pixel positioned identically to the pixel of interest and the pixels in the neighborhood of the identically positioned pixel in the adjacent frame, there is a pixel determined to be correlated with the pixel of interest from the results of the comparisons with the correlation decision threshold value and there is a pixel having the same pixel summing pattern code as the pixel of interest, then from among the pixels having the same pixel summing pattern code, the inter-plane pixel summation unit selects a pixel having the highest correlation with the intra-plane sensitized signal of the pixel of interest; and
if, among the pixel positioned identically to the pixel of interest and the pixels in the neighborhood of the identically positioned pixel in the adjacent frame, no pixel is determined to be correlated with the pixel of interest from the results of the comparisons with the correlation decision threshold value or no pixel has the same pixel summing pattern code as the pixel of interest, then from among the pixel positioned identically to the pixel of interest and the pixels in the neighborhood of the identically positioned pixel, the inter-plane pixel summation unit selects a pixel having the highest correlation with the intra-plane sensitized signal of the pixel of interest.

4. The imaging device of claim 3, wherein
the intra-plane pixel summation unit further comprises
a pixel extractor configured to delay the imaging signal generated by the imaging signal generation unit by different times to simultaneously extract signals indicating the pixel values of the specified pixel and the pixels in the neighborhood of the specified pixel, and
the area selector combines, with respect to the specified pixel, pixels positioned in each of the plurality of areas among the pixels having the pixel values represented by the signals extracted by the pixel extractor, thereby forming pixel combinations constituting the respective areas, and from among the plurality of areas, selects an area with a minimum difference between minimum and maximum pixel values as the area consisting of pixels with high mutual correlation.

5. The imaging device of claim 2, wherein
the intra-plane pixel summation unit further comprises
a pixel extractor configured to delay the imaging signal generated by the imaging signal generation unit by different times to simultaneously extract signals indicating the pixel values of the specified pixel and the pixels in the neighborhood of the specified pixel, and
the area selector combines, with respect to the specified pixel, pixels positioned in each of the plurality of areas among the pixels having the pixel values represented by the signals extracted by the pixel extractor, thereby forming pixel combinations constituting the respective areas, and from among the plurality of areas, selects an area with a minimum difference between minimum and maximum pixel values as the area consisting of pixels with high mutual correlation.

6. The imaging device of claim 5, wherein the inter-plane pixel summation unit further comprises:
a pattern code extractor configured to delay the pixel summing pattern code output from the intra-plane pixel summation unit by mutually different times to simultaneously extract the pixel summing pattern code of the pixel of interest and the pixel summing pattern codes of the pixels positioned identically to the pixel of interest and pixels in the neighborhoods of the identically positioned pixels in the neighboring frames, and
a pattern discriminator configured to determine whether or not the pixel summing pattern code of the pixel positioned identically to the pixel of interest and the pixels in the neighborhood of the identically positioned pixel in the adjacent frame are identical to the pixel summing pattern code of the pixel of interest.

7. The imaging device of claim 5, wherein
the intra-plane pixel summation unit further comprises a signal combiner configured to combine the intra-plane sensitized signal of the specified pixel and the pixel summing pattern code of the specified pixel, thereby generating a composite signal of the specified pixel, and output the generated composite signal; and
the inter-plane pixel summation unit comprises
a pixel extractor configured to delay the composite signal output from the signal combiner of the intra-plane pixel summation unit by different times to simultaneously extract the composite signal of the pixel of interest and the composite signals of the pixels positioned identically to the pixel of interest and the pixels in the neighborhoods of the identically positioned pixels in the neighboring frames,
a pattern discriminator configured to determine whether or not the pixel summing pattern codes included in the composite signals of the pixel positioned identically to the pixel of interest and the pixels in the neighborhood of the identically positioned pixel in the adjacent frame are identical to the pixel summing pattern code included in the composite signal of the pixel of interest, and
a correlation discriminator configured to select one of the pixel positioned identically to the pixel of interest and the pixels in the neighborhood of the identically positioned pixel in the adjacent frame, on a basis of results of comparisons of differences between the intra-plane sensitized signals included in the composite signal of the pixel positioned identically to the pixel of interest and the pixels in the neighborhood of the identically positioned pixel in the adjacent frame and the intra-plane sensitized signal included in the composite signal of the pixel of interest with the correlation decision threshold value and results of determinations made by the pattern discriminator.

8. The imaging device of claim 6, wherein
the neighboring frames include not only the adjacent frame adjacent to the frame of interest but also a distant frame two or more frames distant from the frame of interest; and
the pattern discriminator determines whether or not the pixel summing pattern code of a pixel in the distant frame matches the pixel summing pattern code of the pixel selected in a frame adjacent to the distant frame and located between the distant frame and the frame of interest, and
the correction discriminator selects one of the pixel positioned identically to the pixel of interest and pixels in the neighborhood of the identically positioned pixel in the distant frame, on a basis of a result of comparisons of differences between the intra-plane sensitized signal of the pixels in the distant frame and the intra-plane sensitized signal of the pixel selected in the frame adjacent to the distant frame and located between the distant frame and the frame of interest with the correlation decision threshold value and a result of the determination as to whether or not the pixel summing pattern codes of the pixels in the distant frame match the pixel summing pattern code of the pixel selected in the frame adjacent to the distant frame and located between the distant frame and the frame of interest.

9. The imaging device of claim 2, wherein the inter-plane pixel summation unit further comprises:
a pattern code extractor configured to delay the pixel summing pattern code output from the intra-plane pixel summation unit by mutually different times to simultaneously extract the pixel summing pattern code of the pixel of interest and the pixel summing pattern codes of the pixels positioned identically to the pixel of interest and pixels in the neighborhoods of the identically positioned pixels in the neighboring frames, and
a pattern discriminator configured to determine whether or not the pixel summing pattern code of the pixel positioned identically to the pixel of interest and the pixels in the neighborhood of the identically positioned pixel in the adjacent frame are identical to the pixel summing pattern code of the pixel of interest.

10. The imaging device of claim 9, wherein
the inter-plane pixel summation unit comprises
an intra-plane sensitized signal extractor configured to delay the intra-plane sensitized signal output from the intra-plane pixel summation unit by different times to simultaneously extract the intra-plane sensitized signal of the pixel of interest and the intra-plane sensitized signals of the pixels positioned identically to the pixel of interest and pixels in the neighborhood of the identically positioned pixel in the neighboring frames, and
a correlation discriminator configured to select one of the pixel positioned identically to the pixel of interest and the pixels in the neighborhood of the identically positioned pixel in the adjacent frame, on a basis of results of comparisons of differences between the intra-plane sensitized signal of the pixel positioned identically to the pixel of interest and pixels in the neighborhood of the identically positioned pixel in the adjacent frame and the intra-plane sensitized signal of the pixel of interest with the correlation decision threshold value.

11. The imaging device of claim 10, wherein
the neighboring frames include not only the adjacent frame adjacent to the frame of interest but also a distant frame two or more frames distant from the frame of interest; and
the pattern discriminator determines whether or not the pixel summing pattern code of a pixel in the distant frame matches the pixel summing pattern code of the pixel selected in a frame adjacent to the distant frame and located between the distant frame and the frame of interest, and
the correction discriminator selects one of the pixel positioned identically to the pixel of interest and pixels in the neighborhood of the identically positioned pixel in the distant frame, on a basis of a result of comparisons of differences between the intra-plane sensitized signal of the pixels in the distant frame and the intra-plane sensitized signal of the pixel selected in the frame adjacent to the distant frame and located between the distant frame and the frame of interest with the correlation decision threshold value and a result of the determination as to whether or not the pixel summing pattern codes of the pixels in the distant frame match the pixel summing pattern code of the pixel selected in the frame adjacent to the distant frame and located between the distant frame and the frame of interest.

12. The imaging device of claim 2, wherein
the intra-plane pixel summation unit further comprises a signal combiner configured to combine the intra-plane sensitized signal of the specified pixel and the pixel summing pattern code of the specified pixel, thereby generating a composite signal of the specified pixel, and output the generated composite signal; and
the inter-plane pixel summation unit comprises
a pixel extractor configured to delay the composite signal output from the signal combiner of the intra-plane pixel summation unit by different times to simultaneously extract the composite signal of the pixel of interest and the composite signals of the pixels positioned identically to the pixel of interest and the pixels in the neighborhoods of the identically positioned pixels in the neighboring frames,
a pattern discriminator configured to determine whether or not the pixel summing pattern codes included in the composite signals of the pixel positioned identically to the pixel of interest and the pixels in the neighborhood of the identically positioned pixel in the adjacent frame are identical to the pixel summing pattern code included in the composite signal of the pixel of interest, and
a correlation discriminator configured to select one of the pixel positioned identically to the pixel of interest and the pixels in the neighborhood of the identically positioned pixel in the adjacent frame, on a basis of results of comparisons of differences between the intra-plane sensitized signals included in the composite signal of the pixel positioned identically to the pixel of interest and the pixels in the neighborhood of the identically positioned pixel in the adjacent frame and the intra-plane sensitized signal included in the composite signal of the pixel of interest with the correlation decision threshold value and results of determinations made by the pattern discriminator.

13. The imaging device of claim 1, wherein,
if, among the pixel positioned identically to the pixel of interest and the pixels in the neighborhood of the identically positioned pixel in the adjacent frame, there is a pixel determined to be correlated with the pixel of interest from the results of the comparisons with the correlation decision threshold value and there is a pixel having the same pixel summing pattern code as the pixel of interest, then from among the pixels having the same pixel summing pattern code, the inter-plane pixel summation unit selects a pixel having the highest correlation with the intra-plane sensitized signal of the pixel of interest; and
if, among the pixel positioned identically to the pixel of interest and the pixels in the neighborhood of the identically positioned pixel in the adjacent frame, no pixel is determined to be correlated with the pixel of interest from the results of the comparisons with the correlation decision threshold value or no pixel has the same pixel summing pattern code as the pixel of interest, then from among the pixel positioned identically to the pixel of interest and the pixels in the neighborhood of the identically positioned pixel, the inter-plane pixel summation unit selects a pixel having the highest correlation with the intra-plane sensitized signal of the pixel of interest.

14. The imaging device of claim 13, wherein
the intra-plane pixel summation unit further comprises
a pixel extractor configured to delay the imaging signal generated by the imaging signal generation unit by different times to simultaneously extract signals indicating the pixel values of the specified pixel and the pixels in the neighborhood of the specified pixel, and
the area selector combines, with respect to the specified pixel, pixels positioned in each of the plurality of areas among the pixels having the pixel values represented by the signals extracted by the pixel extractor, thereby forming pixel combinations constituting the respective areas, and from among the plurality of areas, selects an area with a minimum difference between minimum and maximum pixel values as the area consisting of pixels with high mutual correlation.

15. The imaging device of claim 13, wherein the inter-plane pixel summation unit further comprises:
a pattern code extractor configured to delay the pixel summing pattern code output from the intra-plane pixel summation unit by mutually different times to simultaneously extract the pixel summing pattern code of the pixel of interest and the pixel summing pattern codes of the pixels positioned identically to the pixel of interest and pixels in the neighborhoods of the identically positioned pixels in the neighboring frames, and
a pattern discriminator configured to determine whether or not the pixel summing pattern code of the pixel positioned identically to the pixel of interest and the pixels in the neighborhood of the identically positioned pixel in the adjacent frame are identical to the pixel summing pattern code of the pixel of interest.

16. The imaging device of claim 13, wherein
the intra-plane pixel summation unit comprises a signal combiner configured to combine the intra-plane sensitized signal of the specified pixel and the pixel summing pattern code of the specified pixel, thereby generating a composite signal of the specified pixel, and output the generated composite signal; and
the inter-plane pixel summation unit comprises
a pixel extractor configured to delay the composite signal output from the signal combiner of the intra-plane pixel summation unit by different times to simultaneously extract the composite signal of the pixel of interest and the composite signals of the pixels positioned identically to the pixel of interest and the pixels in the neighborhoods of the identically positioned pixels in the neighboring frames,
a pattern discriminator configured to determine whether or not the pixel summing pattern codes included in the composite signals of the pixel positioned identically to the pixel of interest and the pixels in the neighborhood of the identically positioned pixel in the adjacent frame are identical to the pixel summing pattern code included in the composite signal of the pixel of interest, and
a correlation discriminator configured to select one of the pixel positioned identically to the pixel of interest and the pixels in the neighborhood of the identically positioned pixel in the adjacent frame, on a basis of results of comparisons of differences between the intra-plane sensitized signals included in the composite signal of the pixel positioned identically to the pixel of interest and the pixels in the neighborhood of the identically positioned pixel in the adjacent frame and the intra-plane sensitized signal included in the composite signal of the pixel of interest with the correlation decision threshold value and results of determinations made by the pattern discriminator.

17. The imaging device of claim 1, wherein
each of the plurality of areas has one of a set of predetermined shapes;
the inter-plane pixel summation unit selects pixels not only on a basis of the relative position or orientation of the selected area with respect to the specified pixel but also on a basis of the shape of the selected area.

18. The imaging device of claim 1, wherein the neighboring frames include
at least one of a frame one frame period ahead of the frame of interest and a frame one frame period behind the frame of interest.

19. The imaging device of claim 1, wherein the neighboring frames include:
a frame one frame period ahead of the frame of interest;
a frame two frame periods ahead of the frame of interest;
a frame one frame period behind the frame of interest; and
a frame two frame periods behind the frame of interest.

20. The imaging device of claim 1, wherein at least one of the summing of the pixel values by the intra-plane pixel summation unit and the summing of the intra-plane sensitized signals by the inter-plane pixel summation unit is performed by weighted summation, using weighting coefficients determined on a basis of a sensitivity multiplier, the imaging device further comprising:
an illuminance information generating unit configured to generate illuminance information indicating subject illuminance; and
a control unit configured to determine the sensitivity multiplier on a basis of the illuminance information.
